(19) United States
(12) Patent Application Publication
(10) Pub. No.: US 2012/0229449 A1
(43) Pub. Date: Sep. 13, 2012

(54) FILE STRUCTURE AND MANAGEMENT IN 3D AUTHORING SYSTEM

(75) Inventors: IOSIF PSISTAKIS, ATHENS (GR); NIKOLAOS VASILEIOU, PALLINI (GR)

(73) Assignee: EYELEAD SA, Athens (GR)

(21) Appl. No.: 13/291,996

(22) Filed: Nov. 8, 2011

Related U.S. Application Data
(60) Provisional application No. 61/411,271, filed on Nov. 8, 2010.

(51) Int. Cl. G06T 15/00

(52) U.S. Cl. 345/419

(57) ABSTRACT

The present disclosure is directed to improved techniques for encoding 3D media objects in a 3D authoring system. In an exemplary embodiment, encoding involves having a plurality of virtual files each representative of different 3D media objects renderable by a computer, each virtual file having a data structure including (i) first data defining a first set properties of a 3D media object which during a rendering session are not impacted by a change to a second set of properties (ii) second data defining the second set of properties of the 3D media object; and (iii) linking data to link the virtual file, during the rendering session, to other virtual files of other 3D media objects having similar data structures.

### RELATED APPLICATION

This application claims the benefit of U.S. Provisional Application No. 61/411,271, filed on Nov. 8, 2010, commonly owned and assigned to the same assignee hereof.

### TECHNICAL FIELD

The present invention relates generally to the creation and generation of multimedia and more specifically to authoring systems for 3D multimedia content.

### BACKGROUND

The rise of available computing power has triggered a rise in demand for rich audiovisual content in all mediums. From video games to television and motion pictures to multimedia applications, presentations, and the World Wide Web, audiovisual content is becoming more complex, as are the systems used to develop, render and deliver it.

Companies developing audiovisual content usually deploy a collection of software solutions, generally referred to as authoring systems, to create such audiovisual content. Some such authoring systems connect over a computer network environment to provide, for example, file access, file sharing, and/or file management services to the user or users. In addition, typical authoring systems provide a common platform for developers and artists alike to share produced media files created using different proprietary formats. Often, these same developers and artists may create custom software tools to better read and render their respective produced media files. This is particularly the case in the digital entertainment and interactive application industries. It is often further necessary for several developers to be working remotely, each submitting its work at different, disjoint, points in time during development of an application. As a result, conventional authoring systems—due to their non-interactive, complex and time-burdensome nature—ultimately prevent artists and developers from maximizing their creativity, and from fully collaborating with one another in an efficient manner.

### BRIEF DESCRIPTION OF THE DRAWINGS

FIG. 1 is a high level diagram showing an exemplary embodiment of a virtual file layout.

FIG. 2 is a graphical user interface (GUI) of a 3D authoring system according to an exemplary embodiment

FIGS. 3-9 are example screen shots showing a specific user interface for the 3D authoring system customized for game development.

FIG. 10 is a high level diagram describing the modular architecture of the 3D authoring system according to an exemplary embodiment.

FIG. 11 is a functional block level diagram of a device incorporating a 3D authoring system in accordance with an exemplary embodiment.

FIG. 12 illustrates the matching process of visualization and related editing modules of an exemplary (VFS) layout.

FIG. 13 depicts a conventional data structure for a scene graph.

FIG. 14 depicts a VFS data structure of the same scene graph in accordance with an exemplary embodiment.

FIG. 15 shows a distributed collaboration process in accordance with an exemplary embodiment.

FIG. 16 illustrates a peer-to-peer collaboration session in accordance with an exemplary embodiment.

FIG. 17 illustrates a collaboration session based on a central server model.

FIG. 18 graphically depicts real-time collaboration work flow of a scene in accordance with an exemplary embodiment.

FIG. 19 graphically depicts a conventional source control workflow of a scene.

FIG. 20 illustrates a live editing process during which edit mode and play mode are executed at same time.

FIG. 21 describes a dynamic data exchange between two different applications in accordance with an exemplary embodiment.

FIGS. 22-24 are screen shots of a massively multiplayer online game with a casino gaming theme created using a 3D authoring system in accordance with an exemplary embodiment.

### SUMMARY

The present disclosure is directed to improved techniques for encoding 3D media objects in a 3D authoring system. In an exemplary embodiment, encoding involves having a plurality of virtual files each representative of different 3D media objects renderable by a computer, each virtual file having a data structure including (i) first data defining a first set properties of a 3D media object which during a rendering session are not impacted by a change to a second set of properties (ii) second data defining the second set of properties of the 3D media object; and (iii) linking data to link the virtual file, during the rendering session, to other virtual files of other 3D media objects having similar data structures.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The detailed description set forth below in connection with the appended drawings is intended as a description of exemplary embodiments of the present invention and is not intended to represent the only embodiments in which the present invention can be practiced. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

Platform developers of authoring systems have been experimenting with different techniques to achieve multi-user collaboration over a computer network. A typical such authoring system is built on the traditional model of data constituted in the form of a “file”.

A file is generally understood to mean a chunk of data located in a storage device and typically managed under the control of a file manager. Known file managers are operating system platforms that use file naming conventions to open, create, manage, edit, etc. a file. Under operating system control, files can also be transmitted over a network. Files are stored in long-term memory otherwise they cannot be managed by a conventional operating system.

Because modern authoring systems are based on the concept of files, an artist or developer working on a file or set of files will typically be working on a copy of the stored file(s) (typically stored in volatile memory) rather than on the actual stored files. This is done, in order to prevent original file destruction and maintain version control. As significant edits are made to a file, a new file is created and saved. In a networked environment involving many actors, the copying, saving and then transmitting of files through conventional means is very time and process inefficient. Inefficient file creation and exchange substantially impacts overall productivity and application development creativity and therefore quality, cost, and time of production. The need for each actor to maintain his own copy of a file requires having a centralized file versioning system (source control) to track the latest file versions. The exemplary embodiments below describe an alternative to the conventional “file” scheme for authoring system environments. A virtual file system is employed in a manner that better facilitates data creation and provides data management in a way that enhances interactivity and real-time multi-user collaboration, and allows for faster application production and development, particularly in the context of 3D authoring system environments.

Networked authoring systems provide multi-user online collaboration during an editing session. During such a session, multiple users share a same Graphical User Interface (GUI) of an application. An authoring system on one computer relays what is seen on the screen of one user on one computer to remote users working on their remote computers under the control of the same or corresponding authoring system.

These remote users are permitted to take control of the one computer and use that application remotely in their corresponding remote computer. A remote user input is relayed back into the application through the network.

In a typical authoring system environment, users must take turns in controlling the GUI. The sharing of a GUI as a way to achieve multi-user online collaboration is effective for simple reviewing and presenting, but not at all effective or efficient for true, multi-user, real-time collaborative media production.

Real-time collaborative sessions, particularly those involving 3D media production, involve significant workflow changes by many artists and developers, and inefficiencies thereto will result in productivity penalties, as well as performance and scalability issues.

The exemplary embodiments below describe an authoring system architecture and associated techniques to permit multiple users in a collaboration session to simultaneously edit multimedia content.

In an exemplary embodiment, an improved authoring system is provided that allows two or more users to simultaneously edit and view a multimedia content. The authoring system facilitates collaboration in real-time between, for example, developers and artists, or others jointly working to develop a 3D application.

3D type applications are generally understood, for example, to include all types of multimedia type applications ranging from games to movies to an architectural walk through, as well as other similar audio and visual multimedia.

The presently disclosed authoring system enables a first user to edit and display in real time a 3D media content of an application that is being edited by the first user on a portion of a screen, while at the same time a second user also edits the same 3D media content of the application. The result of the editing of the second user is being displayed instantly on the screen of the first user. In a similar manner, the result of the editing of the first user is being displayed instantly on the screen of the second user. Each user is running the authoring system at a separate typical personal computer. The computers are connected to each other through a network.

The authoring system is fully collaborative, allowing any number of users to modify content in real time over a network while all users can view on their screen in real time the results of all their editing on the application. The application that visualizes the media content edited by the first and the second user can be executed simultaneously, in real-time, without any interruption to each user's editing or by forcing the application to pause to allow the viewing by a user.

The authoring system allows the users to collaboratively develop and edit media objects of any type, in real-time and without the need for a version control or a central server system. It also allows users to extend the authoring system features by implementing custom media rendering and editing functionality and to use this functionality to create custom software that is managed and executed by the application.

The proposed authoring system achieves collaboration in real-time by employing the concept of a “virtual file”.

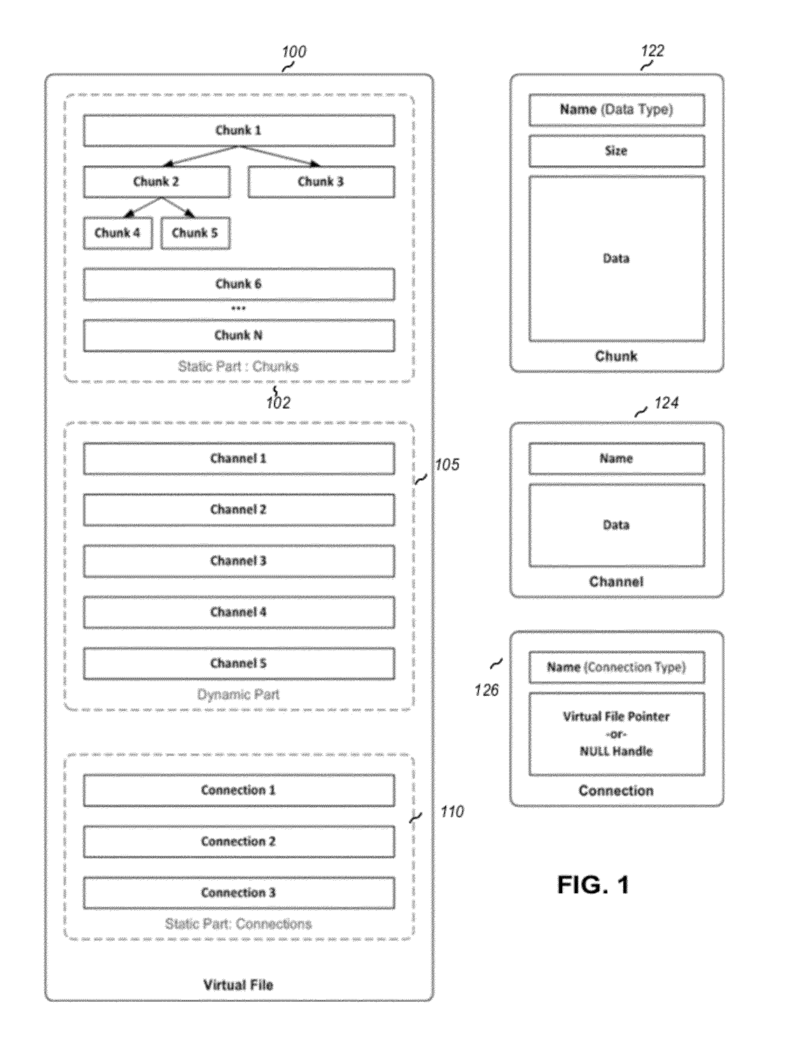

FIG. 1 is a high level diagram showing an exemplary embodiment of a virtual file layout. Virtual files, in general, are abstract chunks of data that can be edited, managed and transmitted between different instantiations of the authoring system over a network or on the same computer in real time and are managed by a corresponding virtual file system (VFS). A virtual file (VF) represents actual data that the user is currently editing.

In contrast to a typical Operating System File, a virtual file does not need to be stored in a long-term storage device (hard drive or otherwise), but exists within the computer's memory (short-term storage, directly accessed by computer software). A VFS, a subsystem of the authoring system, manages the virtual files and ensures that all network-connected users see and edit the same version of the current Virtual Files. This happens transparently without hampering the production pipeline.

Virtual files may describe digital media content of any type, including, but not limited to pictures, graphics, videos, 3D data or interaction logic.

The structure of the VFL shown in FIG. 1 enables type-agnostic processing and management, which in turn allows remote authoring systems to process and manage commonly associated virtual files even when corresponding editing tools are missing.

Virtual Files, by design, represent media objects. A digital photograph is one example of a media object and may exist as a set of binary data within a computer memory. A media object needs to be “visualized” before it can be interactively manipulated. Accordingly, virtual files need to be “rendered”, i.e. processed in a way that produces an output perceivable to the user, before any interactive tools can be applied on them. 3D visualization and audio playback are classic media rendering examples.

In order to render VFs and to allow editing of those files, the authoring system maps visualization algorithms and editing tools to corresponding VFs. The authoring system does this by matching the data structure within a given VF, in accordance to the layout of the VF, to the data structure of a VF currently expected by an editor, visualization engine, or other software tool and is required as input.

An external set of modules, the virtual file handle (VFH) modules, provide all the necessary rendering and editing functionality. This results in an architecture that is versatile and robust, while allowing ad-hoc collaboration to be implemented with minimal effort. New types of media can be easily supported by designing custom VFLs and corresponding VFH modules.

In short, an improved authoring system is provided having the ability to manipulate (e.g., duplicate, move, and/or transmit over the network) virtual files even when the authoring system does not have the means to render and support a specific associated file type. This results in an improved and robust distributed collaboration environment.

An exemplary VF based 3D authoring system in accordance with an exemplary embodiment will be described in greater detail in connection with the appended figures.

The structure of an exemplary VFL of the 3D authoring system is shown in FIG. 1. VF 100 includes a static part 102, 110 and a dynamic part 105. Static part 102, 110 includes a Chunks section 102 and a Connections section 110. A first set of Chunks (Chunk 1 . . . Chunk 5) in the Chunks section is organized in a tree structure and a second set of Chunks (Chunk 6 . . . Chunk N) is organized in a non-tree structure. Each Chunk 122 includes: a Name (and optionally a Data Type) portion, where the name and data type of the chunk is included; a Size portion, where the size of the chunk is included; and a Data portion where the actual data is included.

The Connections section 126 includes a set of connections (Connection 1 . . . Connection 3) or links to other VFs of the system. Dynamic part 105 includes a Channel section. The Channels section includes a set of Channels (Channel 1 . . . Channel 5) each including an attribute of VF 100 that is fast-changing over time. Each Channel 124 and Connection 126, similarly to chunk 122, includes a Name portion and a Data portion.

Chunks may define a set of properties of a 3D media object that during a rendering session are not impacted by a change to a set of properties defined by Channels. Chunks and Connections are considered non-frequently changing. Channels are categorized as frequently changing over time. An example of a property of chunks may be the surface of a 3D object. An example of property of a Channel may be one of a position, a rotation or a scale of a 3D object. Connections or linking data includes links to other VFs that may represent one of a light, a material or a color of a 3D object.

Users may process and manage the data that each VF encapsulates. We shall refer to this action as editing of a VF. The authoring system processes data-agnostic attributes and features of the VF to ensure data integrity and synchronization, both on each computer system and across the network. This action we shall refer to as managing the Virtual File.

The authoring system offers an integrated environment that allows users to browse Virtual Files and use tools to edit those files. Furthermore, it allows users to connect to remote computers and, when given sufficient authority, view or edit remote Virtual Files. Changes are propagated in real time through the network through an automated transfer system. As a result, team members can instantly share, view and edit any virtual file on the network in a distributed, ad-hoc manner. The authoring system disclosed herein focuses on streamlining the real-time collaboration between multiple users. Furthermore, the authoring system disclosed herein is directed to providing a development platform that allows seamless online integration and collaboration.

The User Interface

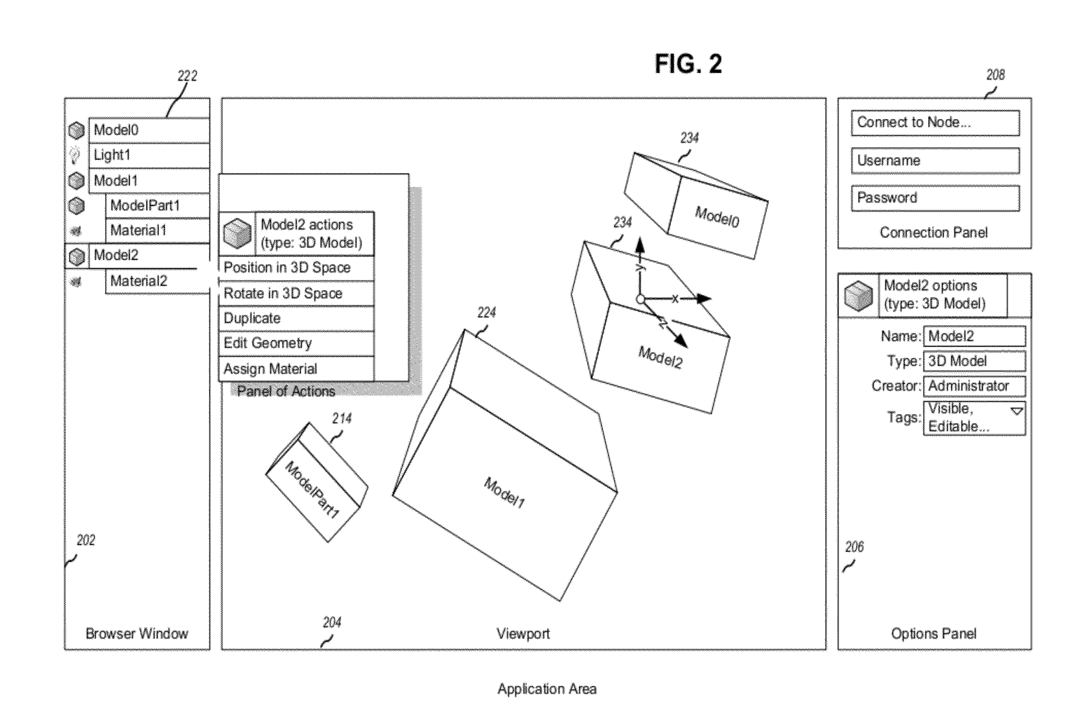

FIG. 2 is a graphical user interface (GUI) of a 3D authoring system according to an exemplary embodiment. The GUI, as shown, includes Browser Window 202, Viewport Panel 204, Options Panel 206 and Connection Panel 208. Here, the GUI displays (i) a plurality of media data (214, 224, 234, 244) that the user is editing or viewing in the viewport panel and (ii) a structure of Virtual File System 222 in Browser Window 202. The same GUI can be extended to display the User Interface of the editing tools that act on the virtual files that the user selects.

The Browser Window displays the current loaded set of Virtual Files. The Viewport Panel displays the rendered output of a set of the loaded Virtual Files. The Viewport Panel also allows users to collaborate and interact in the 3D space by allowing each user to select the rendered output (such as 3D items) that is visible and change the point of view of the viewport panel in real time. The Viewport Panel further allows each user to drag 3D Editing handles that are placed within the Viewport Panel, either by the Editing environment or by any editing tool that acts on the Virtual Files. The purpose of the 3D Editing Handles is to simplify editing (3D manipulation) operations for the user.

The Options Panel is a placeholder for all numeric inputs and processing options. Any editing tools that act on the Virtual File Hierarchy, may display options as additional panels in the Options Panel. The Connection Panel may be used to graphically facilitate initiating a remote collaboration session.

As previously described, Virtual Files are organized in a hierarchical tree structure. Users can organize this hierarchy and browse or search for Virtual Files through the Browser Window. The Browser Window allows users to select a Virtual File and open a Panel of Actions. Through the Panel of Actions, users may perform various tasks on the Virtual Files and the data included in the Virtual Files. Such tasks may be generic file management tasks like renaming, duplicating, deleting or changing the hierarchy. They may also be generic media editing tasks on the media objects represented within the Virtual Files. Generic media editing tasks include 3D position, rotation, visibility and the like. Such properties can be set on all virtual files. Software tools that can be applied to any type of Virtual File are called Generic Tools (or Generic Editors).

Editing Tools can be designed for each type of media content and its corresponding Virtual File Layouts. Such tools may display both data and editing inputs, both in the Viewport panel (in 3D space) and in the Options Panel (2D interface). Each type of media content is associated with a set of Virtual File Layouts, and each Virtual File Layout is edited through a set of Editing Tools. Such Tools may be either type-specific, or generic, i.e. acting on all Virtual File Layouts.

The user interface of FIG. 2 is an example GUI of an authoring system for 3D video game development. In the 3D video game development GUI shown in FIG. 2, three types of Virtual Files are being employed in the Browser Window. A first type of Virtual File depicted as “Lights” includes lighting information for a 3D Scene displayed in the Viewport panel. A second type of Virtual File “3D Models” describes the geometry of the objects that exist within the 3D Scene. A third type of Virtual File “3D Materials” describes the visual properties of 3D Models.

For the sake of clarity, in the following paragraphs, the word “scene” refers to a collection of multimedia data (images, sounds, structures etc), used in the context of an application.

Users may create a duplicate of a 3D model by selecting the corresponding Virtual File, which is a 3D file, bringing up the Panel of Actions and then selecting “Duplicate File” action. This action creates a duplicate of the selected 3D model, which the user may want to reposition in 3D space.

To position the newly created Virtual File in 3D space, the user would select that Virtual File, bring up the Panel of Actions and choose the “3D Transform” action. This action brings up the generic 3D transform editor that allows users to position the item in 3D space. The 3D transform editor is an example of a generic Editor that can be applied in all types of Virtual Files. It brings up a numeric input in the Options Panel that allows each user to set the position of the object represented by the Virtual File by inputting the desired 3D coordinates. It also simultaneously creates a 3D user-interaction handle in the Viewport panel, which allows each user to place the object in 3D space visually.

The Panel of Actions may also contain some 3D Model-specific actions, like “Edit Mesh”. The Edit Mesh action allows the user to utilize the 3D mesh editor and to change the geometry of a newly created 3D Model.

In a similar fashion, users may duplicate the Lights Virtual File using the “Duplicate” action in the Panel of Actions and then reposition the Lights Virtual File using the “3D Transform” action. However, instead of an “Edit Mesh” action, the Panel of Actions contains an “Edit Light” option, which brings up the 3D Light Editor, allowing users to manipulate the light-specific properties of that Virtual File. Each of the type-specific editors is defined within the custom system module that defines that type. As third-party developers make new media types available, they may also provide an editing toolset for these media types. This basic user interaction model can be easily extended to support complex user interactions in an artist-friendly workflow.

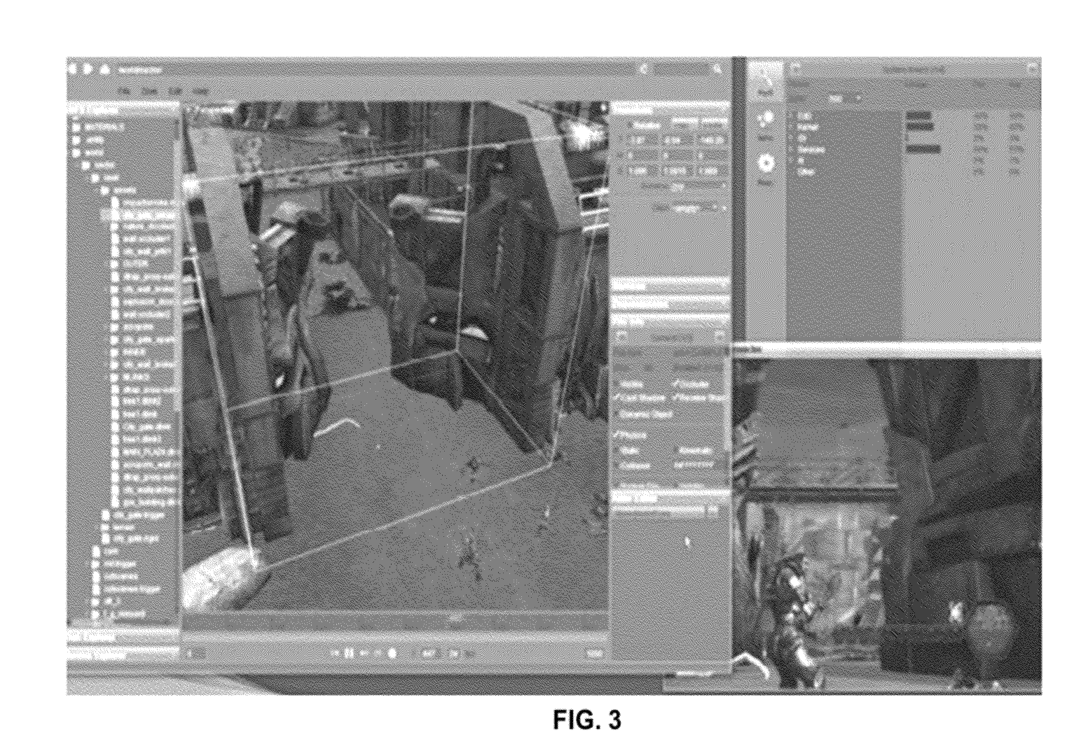

FIGS. 3-9 are example screen shots showing a specific user interface for the 3D authoring system customized for game development.

More specifically, FIGS. 3-9 are screen images or screen shots of images displayed on a monitor of a user's computer during operation of the authoring system. Thus, FIGS. 3-9 demonstrate what a user would typically view on a computer monitor when running the authoring system on a typical personal computer. As can be readily seen and understood from these screen shots, any change to any media content by the user is instantly displayed in the 3D game while it is actually actively running. This allows the developer or artist involved in game creation to, for example, edit active objects in a 3D game scene and to instantly visualize the look and feel of the changed interface as the game is up and running. For the first time, true “real-time” editing is made possible through this process. Real-time editing, of course, results in the much desired benefit of more quickly being able to visualize changes on the fly, which in turn allows greater flexibility to experiment with more changes and ultimately arrive at a best user experience for a particular scene in the shortest amount of time.

The authoring system is designed to provide a user interface that allows for real time editing of the 3D game while the game runs. Furthermore, it provides a user friendly and feature rich interface environment that enables the user to edit Virtual Files of varying types, such as materials, and instantly view the results of the programming actions in the game that simultaneously runs and is displayed on the user's screen.

FIG. 3 shows an example of a screen shot of the graphical user interface (GUI) of the authoring system. A Browser Window provides a tree view of a Virtual File System structure. A 3D Viewport Panel allows editing controls on Virtual Files such as spatial move/rotate/scale, virtual file flags. A Preview Panels visualizes a sub-tree of the Virtual File System (under the “World” node). A System Monitor Panel provides general performance measurements and health information for the Virtual File system. Any editing taking place in any of the windows and panels runs in parallel with a 3D game under development.

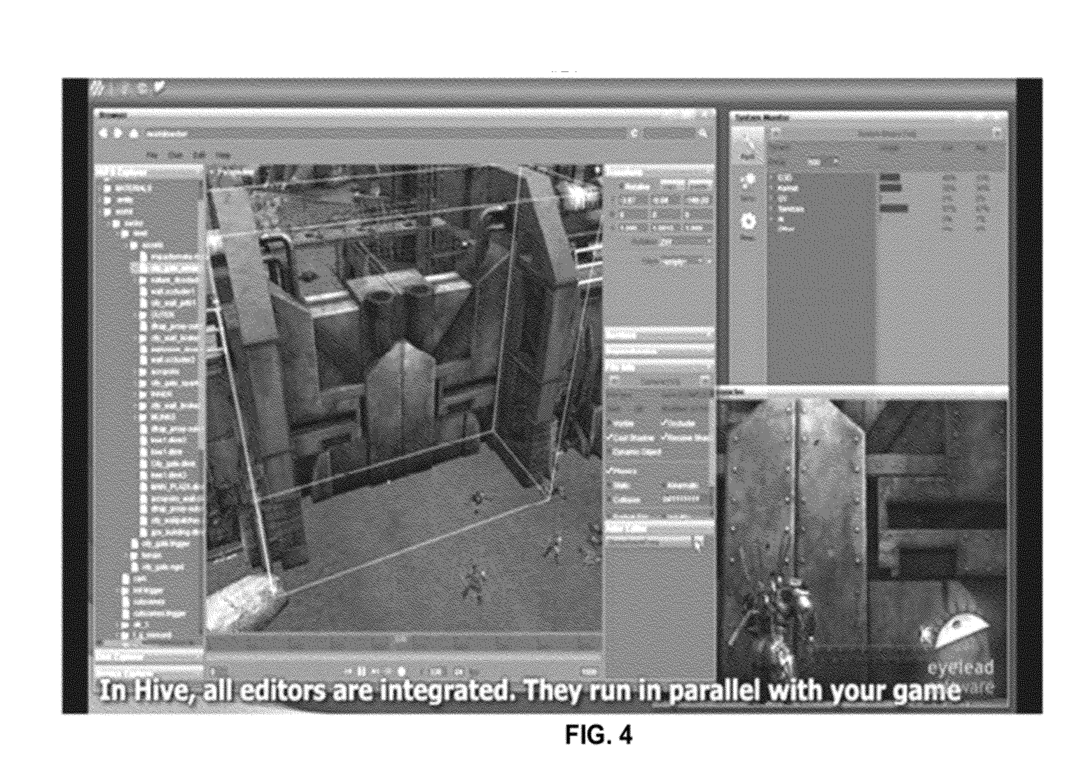

FIG. 4 shows another example of a screen shot of the graphical user interface (GUI) of the authoring system.

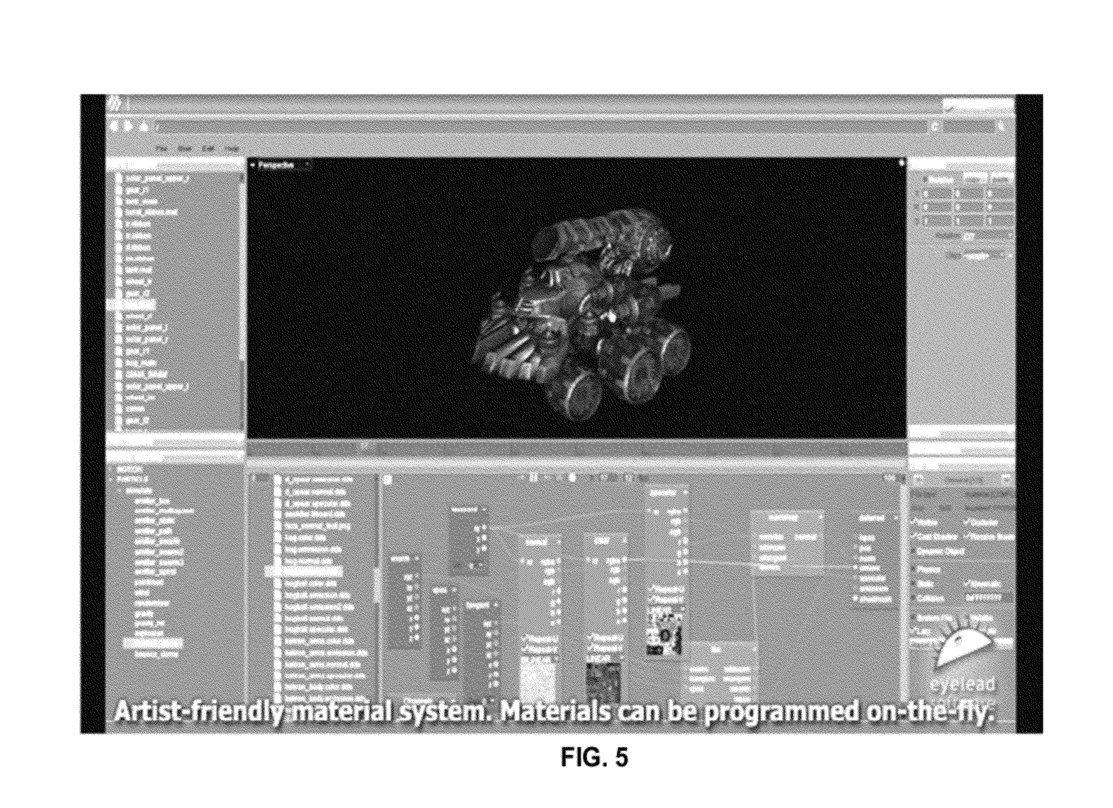

FIG. 5 shows an example of a screen shot of the authoring system wherein, windows and panels are sharing virtual files and resources. A Browser Window provides a tree view of a Virtual File System structure, a 3D Viewport Panel and common editing controls on Virtual Files. A Virtual File of type “material” has been selected in the editor. For the Selected Virtual File, the corresponding Editor Application (“Material Editor”) has been brought up and seamlessly integrated inside the Browser Window by GUI of the authoring system. Changes in the Material Editor are instantly reflected to the corresponding file. Exemplary User Interface with applications sharing virtual files and resources

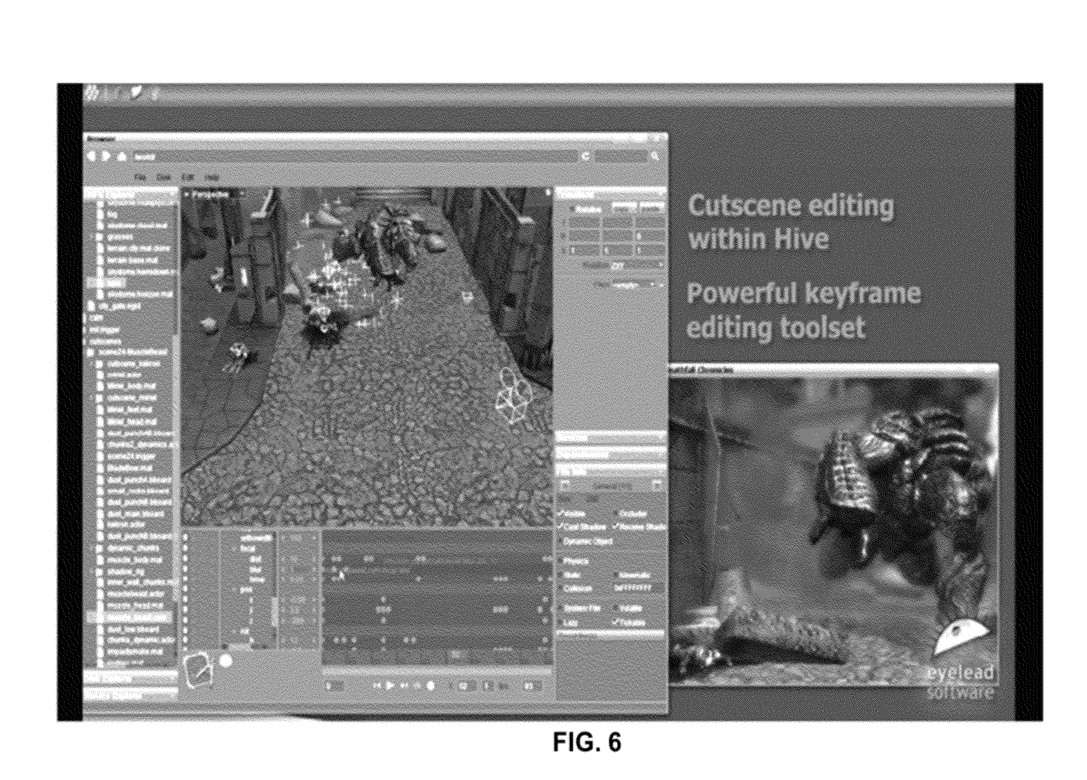

FIG. 6 shows an example of a screen shot of the authoring system, wherein two Virtual Files of two different types are edited concurrently.

Virtual Files include channels to store time-varying information, such as animation. This allows for example, a “Channel Editor” application to be used to edit channels (animation information) of the selected Virtual Files, regardless of their type.

In the example of FIG. 6 the “Channel Editor” application has been activated for the selected Virtual Files and has been seamlessly integrated within the Browser Window. At the same time, within the “Channel Editor” application, users of the authoring system can place “keyframes” to define the value function of each channel over time using interpolation methods.

A Viewport Panel Application is also running, visualizing the Virtual File Hierarchy from another view of the scene being edited.

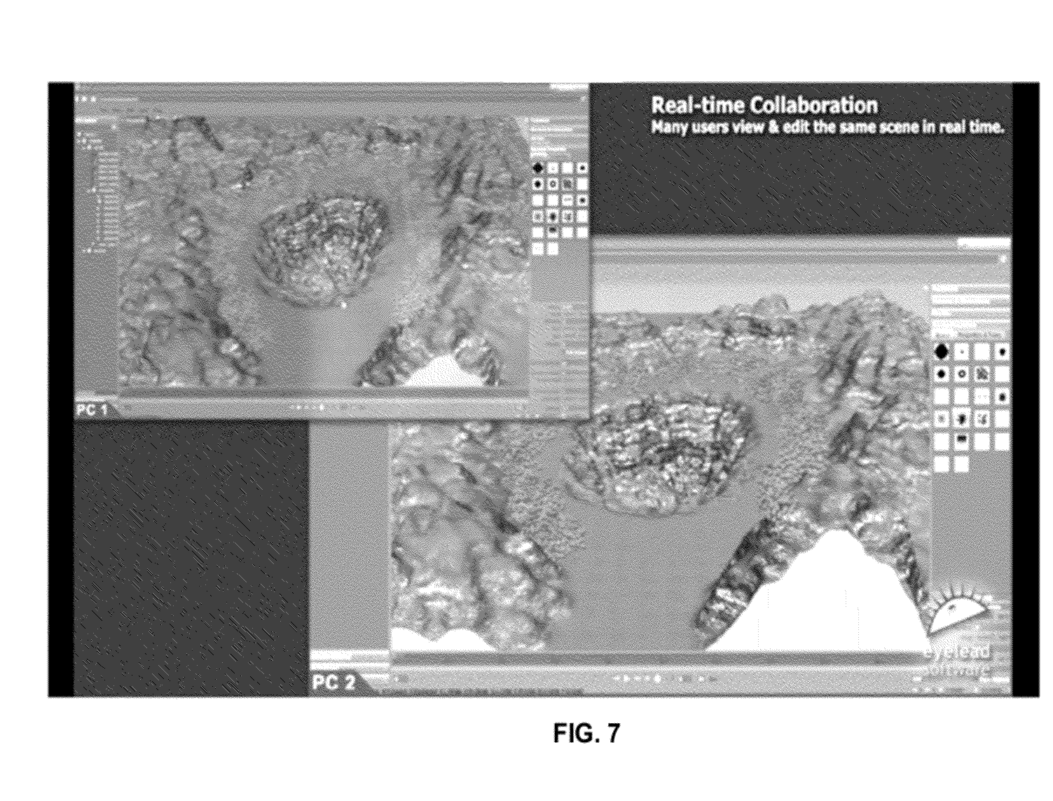

FIG. 7 illustrates two users editing and viewing the same scene in real time. In this example, two users sculpt and populate a terrain belonging to the same scene of a 3D game in parallel. Each user is running the authoring system at a separate typical personal computer. The first user uses the user interface of the authoring system to edit a Virtual File of the scene at the top most left window on personal computer 1 (PC1). The second user users the user interface of the authoring system to edit a different Virtual File of the same scene at the bottom left window on personal computer 2 (PC2). The first user views any editing by both users to the media content of the 3D game instantly on the screen of PC1. The second user views any editing by both users to the media content of the 3D game instantly on the screen of PC2.

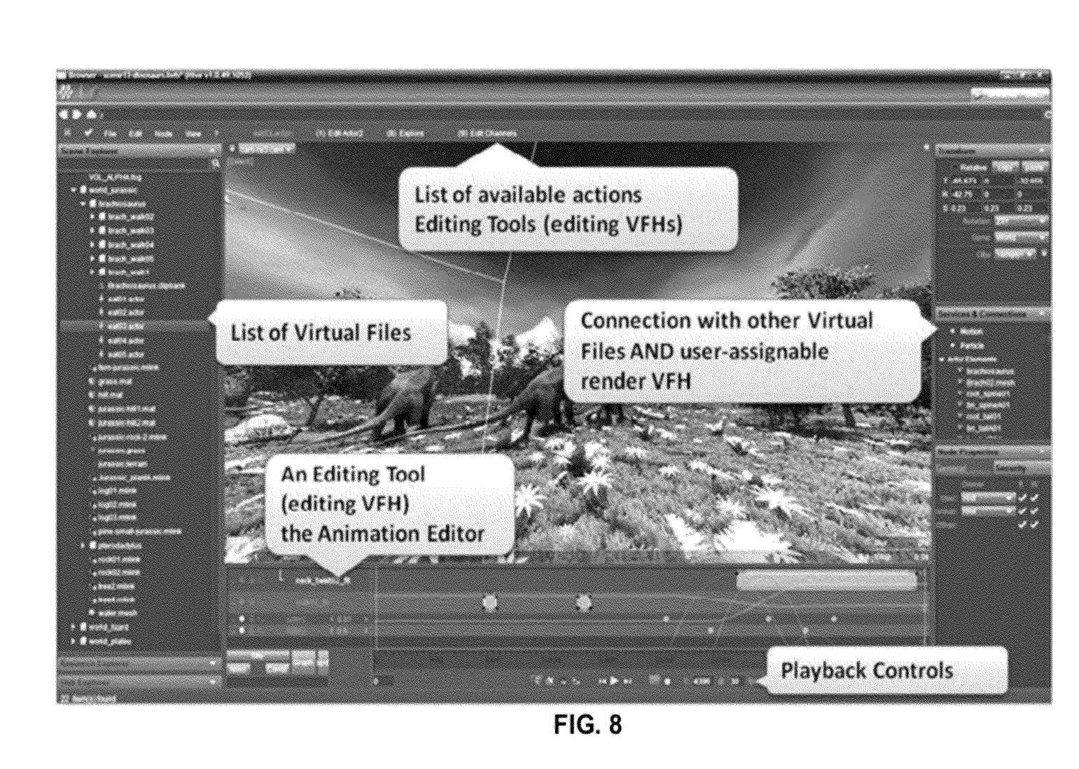

FIG. 8 shows an example of a screen shot of the authoring system, wherein key components of the authoring system are shown.

A tree view of the Virtual File Hierarchy may be used to select a Virtual File. The actions available (tools and functionality) for the selected virtual files is showcased in a List of Available Actions. Connections of the selected Virtual File with other Virtual Files in the Virtual File Hierarchy are showcased and edited through a Services and Connections panel. In addition, custom, user-assignable render Virtual File Handles, labeled as Services, are also managed.

On the bottom edge of the screen shot, a Playback Controls provides common controls for playing/pausing the time, defining the desired playback speed and other time-related and interaction-related global controls.

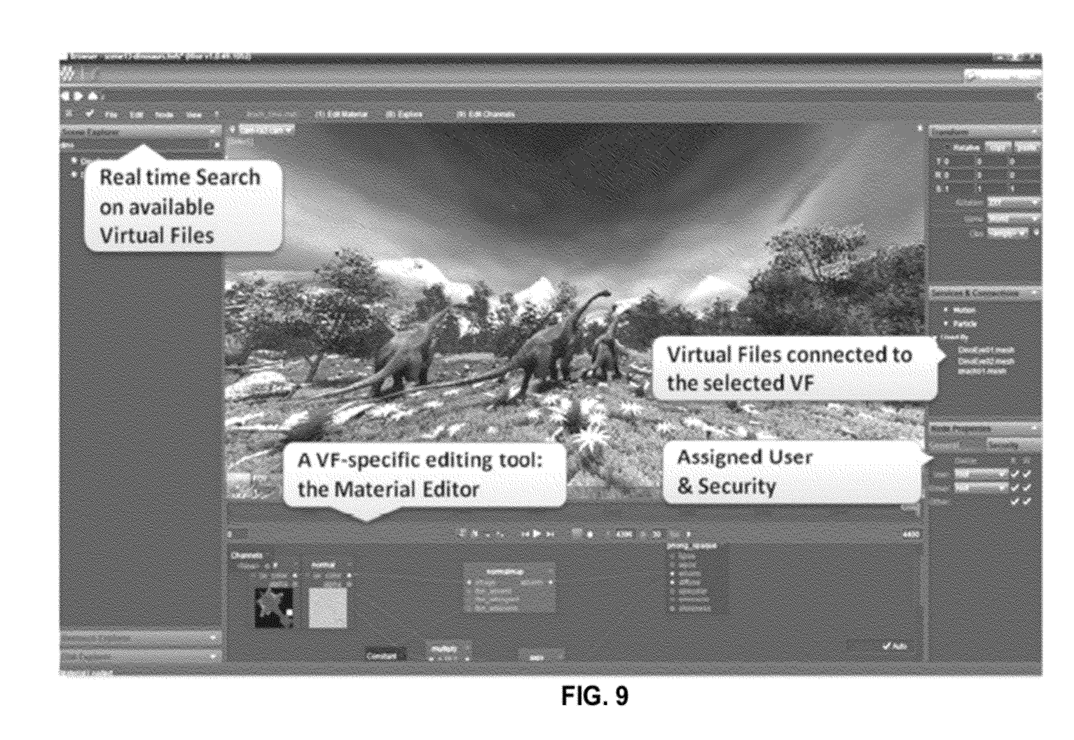

FIG. 9 shows an example of a screen shot of the authoring system, wherein key components of the authoring system are shown. The tree view of the Virtual File Hierarchy has a real-time search feature. An input box initiates search-as-you-type functionality, which greatly helps the user locate and select virtual files. Once in search mode, the tree view is hidden and a list of Virtual Files discovered that meet the search criteria is displayed. This flat list can be used as if it was an actual tree view for selecting and activating editing functions on the Virtual Files.

For the selected Virtual Files not shown, as they are currently hidden as they do not meet the search criteria, a material editor panel has been activated.

The selected Virtual File is called Brach_One.mat, as displayed in the top edge of the screen shot and it is of the Material type.

To the right of the screen shot shown, three outbound connections from the selected Virtual Files are displayed. This suggests that the selected Virtual File is connected, in this case as a Material, to the Virtual Files DinoEye01.mesh, DinoEye02.mesh and Brach01.mesh. Security flags, such as owner and group, for the selected Virtual File are also displayed in a security panel.

The example screen shots make evident that the authoring system presented streamlines real time on line collaboration for the development of 3D media content. It allows users to collaborate in a transparent manner that encourages user interaction and collaboration as it enables a number of users to exchange ideas quickly and easily in real time as opposed to saving different versions of the media content. The authoring system enables each user to setup each scene without recompilation and reloads of the 3D media content. As a result the development time of a 3D application is drastically reduced.

Authoring System Architecture

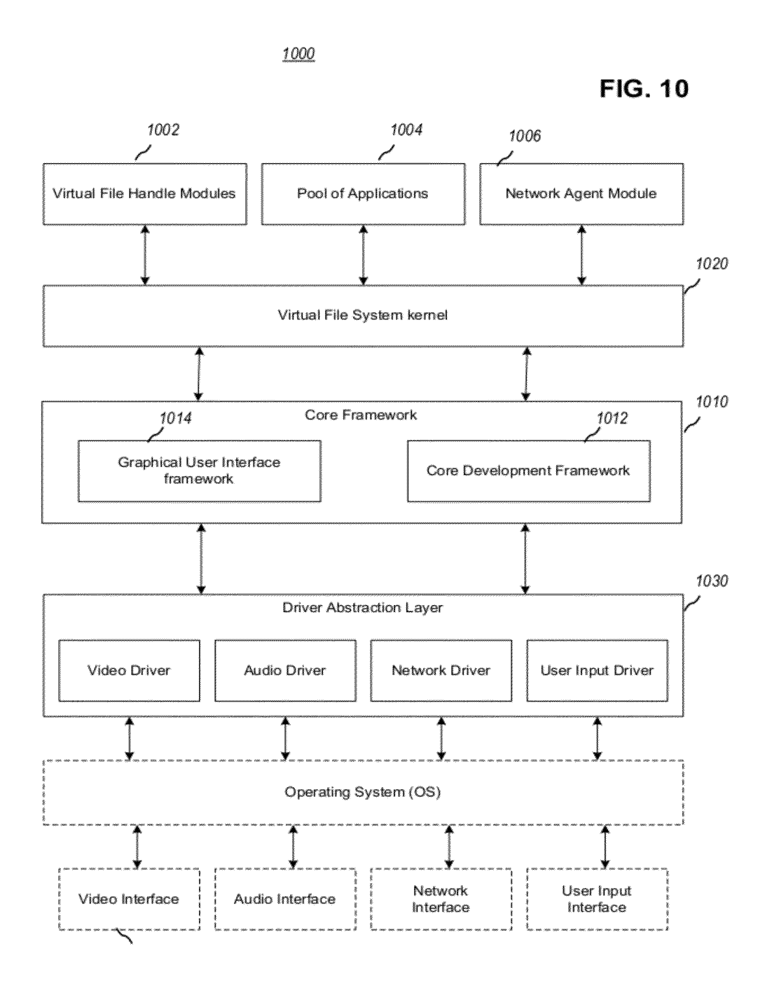

FIG. 10 is a high level diagram describing the modular architecture of the 3D authoring system according to an exemplary embodiment.

Modular architecture 1000 is built around a central module, Core Framework module 1010. In one embodiment, Core Framework module 1010 includes Core Development (CD) Framework 1012 and Graphical User Interface (GUI) Framework 1014.

Each of CD and GUI Frameworks 1012, 1014 comprise a set of libraries. CD Framework 1012 comprises a set of libraries that are used throughout the system and made available to developers through an Application Programming Interface (API). CD Framework 1012 makes the code-base modular and manageable. Custom modules may be developed for supporting on one side different operating systems and hardware implementations and on the other side application development. To allow this, GUI Framework 1014 comprises a set of libraries defining GUI objects that provide the necessary user interaction framework both for 3D-space and 2D-space interactions. GUI Framework 1014 is implemented to allow development of cross-platform applications, editors and option dialogs. The libraries of Core Framework 1010 are designed and selected so that they can be supported by the majority of current hardware implementations as well as operating systems. This allows Core Framework 1010 to be loaded in almost any known device that is designed to handle multimedia content, let alone 3D games.

Using a system's API, the developer can easily define and register the VF Layout. VFH modules 1002 can then process the data within each file element and use abstraction layers to map the authoring system routines to compatible operating system calls allowing the authoring system to remain platform agnostic.

The VFH modules include a set of helper routine libraries that can be used for:

(i) addressing the underlying computing architecture and use of resources such as video drivers, audio drivers, network drivers and user input drivers;

(ii) providing feedback to the user and reading user input with the use of a GUI that may include 3D widgets and/or interface panels;

(iii) performing data-intensive calculations (e.g. a Math library); and

(iv) searching, moving, duplicating or accessing Virtual Files in the system and their data and any file functionality.

Apart from the VFH modules component, another component that taps on VFS kernel module 1020 is Pool of Applications component 1004. Pool of Applications component 1004 includes a set of Applications that use the underlying modules and implement custom logic to provide a full-featured rendering or editing solution. Media editors, scientific simulators, performance profilers, virtual reality applications, video games or related applications can be developed as Custom Applications, based on the authoring system's core components (the VFS kernel and the Core Framework). Since each application communicates with the authoring system core components to visualize and manage modules, applications running concurrently can share their media data dynamically and communicate with each other.

Network Agent Module 1006 is a core component that is responsible for connecting an authoring system instance to other authoring system instances through the network and synchronizes remote Virtual File data with local Virtual Files as needed. Thus, each user's actions in an authoring system instance are instantly mirrored to other authoring system instances across the network.

All user-editable data in the authoring system are stored as Virtual Files. Each Virtual File is structured in such a way as to include data components that encapsulate media data of any type (including 3D models, 3D materials, images etc). As mentioned earlier, a VF comprises of two basic parts; a static part and a dynamic part.

The composite structure of the static and dynamic parts is called the Virtual File Layout. The static part includes data components of two types, a tree of data components called chunks and data components called connections. Chunks are used to describe data that do not change over time.

An example of a chunk is a 3D object (or mesh) having a surface described by points in a coordinates system. Chunks may be arranged in a tree structure within the VF Layout. Some of the chunks are vital for the media to be stored (for example an image needs to have pixels) and are thus obligatory. Others are less important (for example, textual descriptions of the image) and may be missing from the structure.

To classify the Virtual File, the system matches the chunks existing in that file with the obligatory parts of the available Layouts. It then attaches all File Handles for the matched Layouts to that VF. Connections describe properties of a chunk that are associated with another Virtual File. In our example of the 3D object such qualities may be the color, the material or the texture of the 3D object.

The dynamic part includes data components of a type named channels. Both types are used to describe properties that may change over time. Channels describe properties of a chunk such as position, rotation or scale of the chunk. A Channel encodes time-variable information as a function of time. This function can either be defined by a mathematical expression, or by a set of values to be interpolated over time. As with chunks, some channels are obligatory for the VFH modules to function while others are optional.

It should be noted that to implement some functionality, a VFH module may need additional information which may be impossible, or impractical to encapsulate within a single Virtual File. A mechanism allows for a Virtual File to make reference to another Virtual File which may appropriately encapsulate pertinent information. In this context, it is possible to link two Virtual Files (not necessarily of the same media type) through a Virtual File Connection, declaring a relationship between the two. Their corresponding VFH modules may then use that Connection to extract additional information that may be required for implementing specific functionality. It is also possible that a Virtual File Handle module may request specific functionality by the VFH modules attached to the connected Virtual Files.

The authoring system does not distinguish between media types when managing Virtual Files, just as an Operating System does not distinguish between files. Therefore, basic functionality like data duplication, data transfer, remote data access and import/export can be applied to any Virtual File. This allows also for non-type-specific tools that operate on any Virtual File to be implemented. However, the fact that Virtual Files adhere to a specific data encapsulation blueprint allows for the system to associate visualization and editing services to specific Virtual Files, therefore being able to render and edit related media types.

This feature is important, because, in contrast to other implementations, it allows the system to be flexible and expandable. Moreover, it is the key enabler for distributed collaboration, since it allows seamless data exchange and synchronization.

With the proposed modular architecture a number of functions are enabled related to the development and the execution of 3D applications. Each of these functions is unique and innovative and made possible by the modular architecture of the proposed authoring system.

The modular architecture of the authoring system permits the ubiquity of the authoring system because all hardware and operating systems communicate with the Core Framework module through Driver Abstraction Layer (DRV) (1030) module. The DRV module is used to address the underlying hardware and operating system.

The DRV module includes all the necessary Drivers that are needed to support a plurality of operating systems and hardware. Such drivers may be Video Drivers, Audio Drivers, Network Drivers, User Input Drivers and the like. One skilled in the art may appreciate that any type of driver that allows communication with an underlying hardware or operating system may be part of the DRV module.

The DRV module allows for the major part of the authoring system to remain platform-agnostic by implementing architecture-specific functionality for the system. Furthermore, the DRV module allows for any current or future technology platforms to be integrated with the authoring system in a seamless manner by including corresponding new drivers in the DRV module.

It should be noted that the DRV module is modular itself, meaning that each driver that forms part of the DRV module is perceived as an independent module per se. This allows for selectively activating the required driver modules necessary for the authoring system to be executed in a specific hardware platform or operating system 1040.

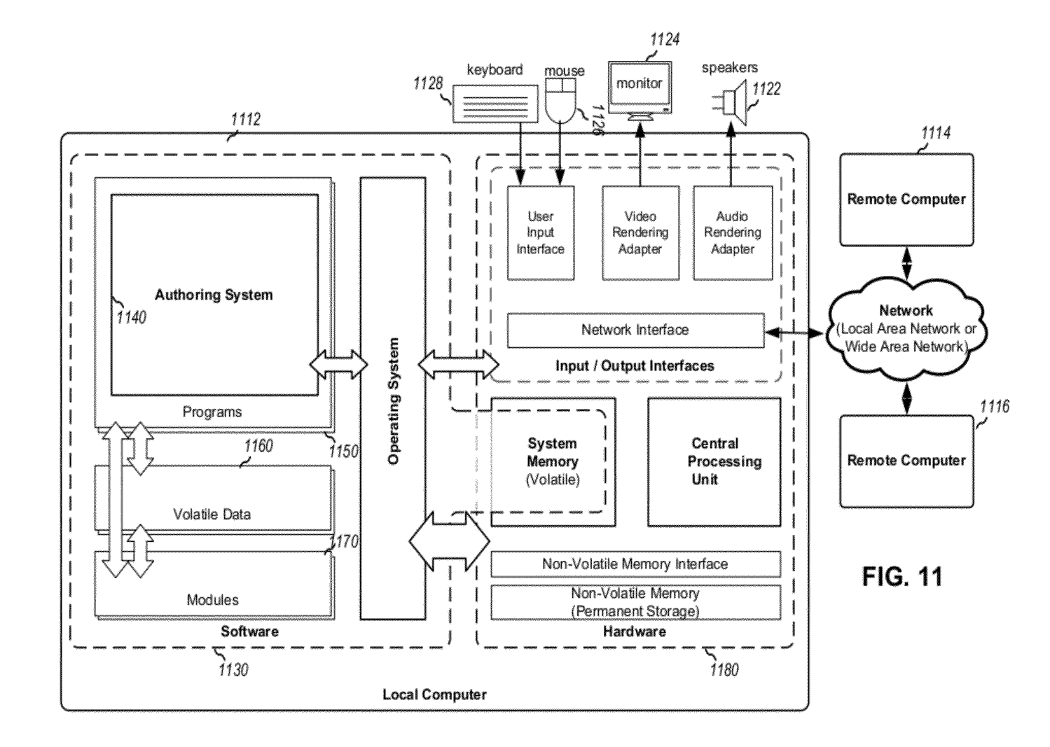

FIG. 11 shows a functional block level diagram of a device incorporating an authoring system in accordance with an exemplary embodiment. Device 1112, also referred to as a local computer, includes a plurality of hardware components, such as a central processing unit, a volatile system memory, a non-volatile system memory and input/output interfaces.

The input/output interfaces may include components such a user input interface, a video rendering adapter and an audio rendering adapter. The user interface may interface to keyboard 1128 and mouse 1126. The video rendering adapter may interface to monitor 1124. The audio rendering adapter may interface to speakers 1122. The input output interfaces may include a network interface for the local computer to connect to remote computers 1114 and 1126 through a network.

Device 1112 includes various software programs 1130. Authoring system 1140 may be one of a set of programs 1150 residing in the volatile system memory. The authoring system may communicate with operating system 1180 and volatile data 1160 and software modules 1170.

In the exemplary embodiment for FIG. 11, the authoring system is shown as part of the device's system memory, and is executed and managed by the module Operating System.

The operating system acts as an abstraction layer between the hardware components and the authoring system. It provides abstraction layers for managing all aspects of hardware, through services that the authoring system uses.

The Core Framework of the authoring system manages Operating Systems and hardware interfaces through the DRV module. In addition, the Core framework manages Virtual Files through a Virtual File System (VFS) kernel module. The VFS kernel module includes a set of software routines that manage Virtual Files. In addition, they dynamically allocate Editing Tools and resources to their corresponding Virtual Files, allowing proper rendering and editing of arbitrary types of media.

Typical software routines of the VFS kernel module include data and process management, file-system management and scheduling. That is, the VFS kernel module is a high-level framework for applications (i.e. games) and for the editing tools of those applications.

The VFS kernel module handles the top layer components of the authoring system. Top layer components may include a Virtual File Handle (VFH) modules component, a Pool of Applications component and a Network Agent Module component. Each top layer component is responsible for a different function of the system.

The VFH modules component is a set of external modules that provide media-specific rendering and editing functionality for known media types. Each Virtual File Handle module defines the behavior and characteristics of a set of Virtual Files. All the Virtual File-specific rendering and editing algorithms are implemented within the Virtual File Handle modules component.

To implement support for new media types, a new VF Layout must be defined by a developer. It is registered in all the corresponding Virtual File Handle modules and defines the required Virtual File Chunks, Channels and Connections that need to be present in a Virtual File in order to be processed.

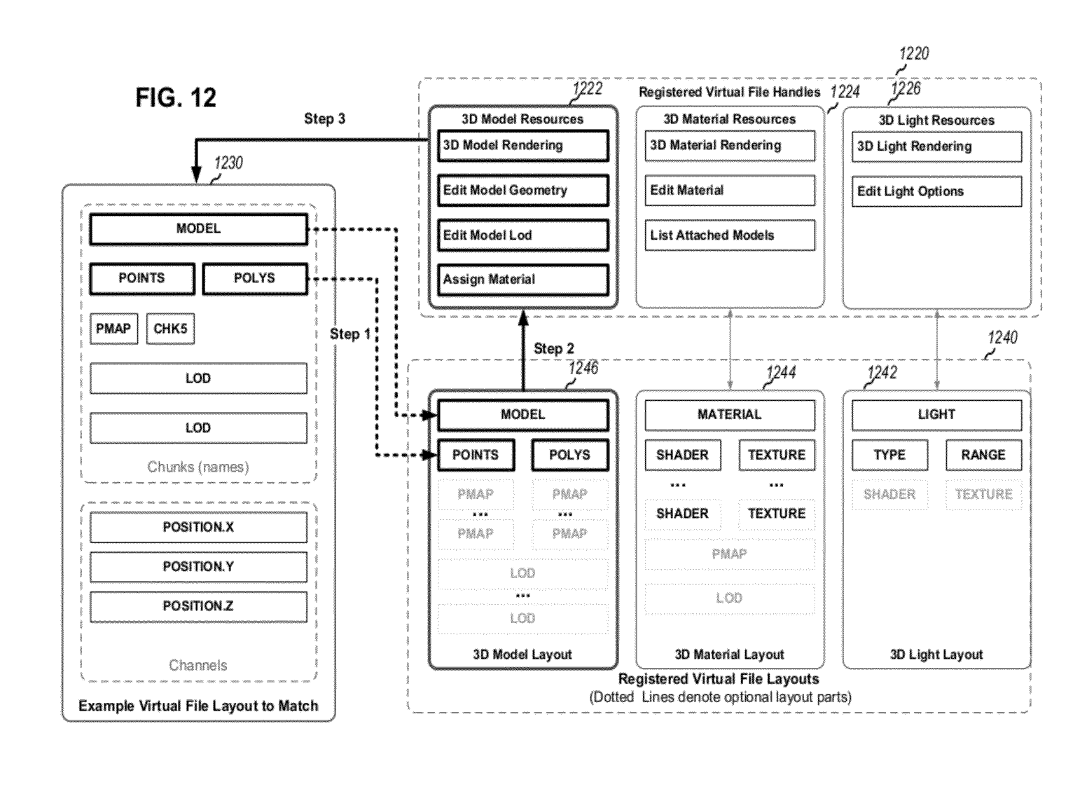

FIG. 12 illustrates the matching process of visualization and related editing modules of an exemplary (VFS) layout.

In the example of FIG. 12, VF 1230 has a VF Layout where a set of chunks includes at least a Model chunk, a Points chunk and a Polys chunk. In a first step, a matching process accesses a Registered Virtual Files Layout module 1240. Module 1240 includes at least module 1246, module 1244 and module 1242. In module 1240 there exists 3D Model Layout 1246 that is matched with the Layout of VF 1230.

In Step 2, Registered Virtual File Handles module 1220 includes 3D model resources handle 1222, handle 1224 and handle 1226. 3D model resources handle

1222 includes a set of functionalities that allow editing or rendering of VF 1230. In the example of FIG. 12, such functionalities include 3D Model Rendering, Edit Model Geometry, Edit Model Lod and Assign Material. One skilled in the art may appreciate that these functionalities are merely shown as examples. Any functionality may be part of 3D Model Resources Handle 1222. Finally, in Step 3, these functionalities are performed on VF 1230 to update at least one property of a chunk of VF 1230.

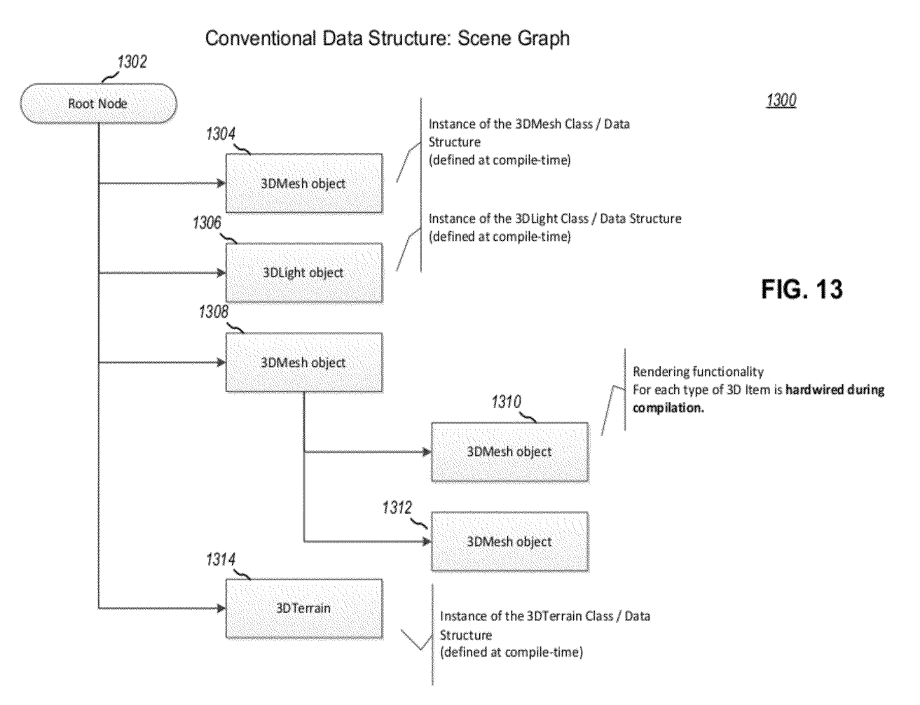

FIG. 13 depicts a conventional data structure for a scene graph.

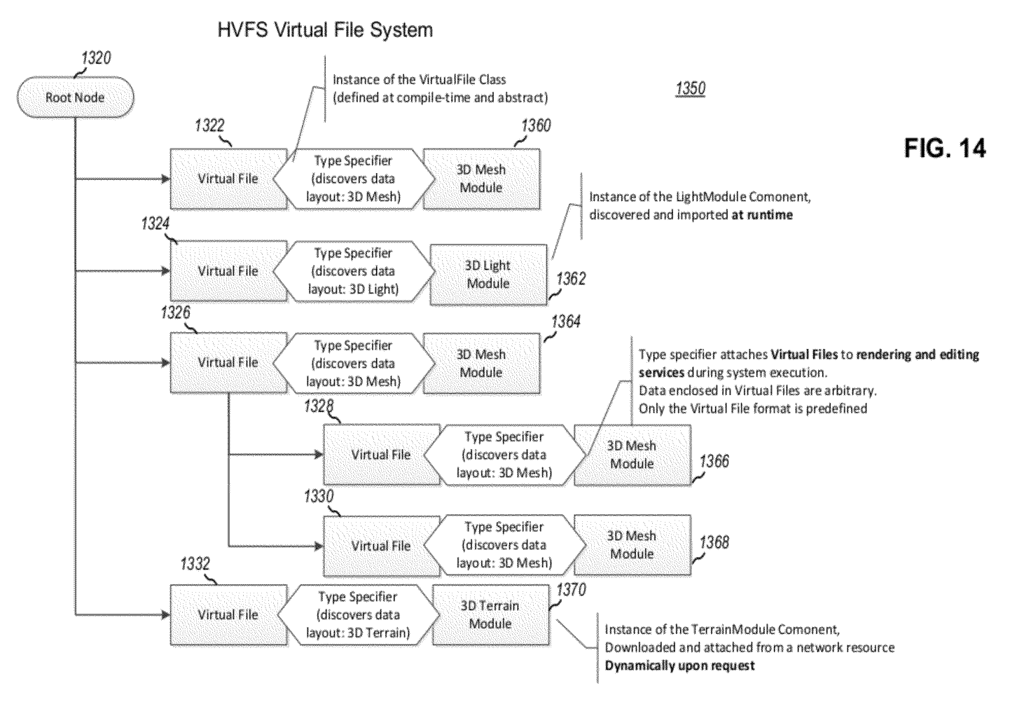

FIG. 14 depicts a VFS data structure of the same scene graph in accordance with an exemplary embodiment. As shown, in a traditional Scene Graph Model 1300, a scene hierarchy is implemented using Class-based objects (1304, 1306, 1308, 1310, 1312 and 1314). All items in the tree extend a Scene Node class and use Scene Node methods and data members to implement the hierarchy.

Most importantly, the objects attached in the scene graph are identified at compile-time and new types of objects cannot be attached dynamically at run time. The data structures need to be well established. Only systems that implement all functionality (i.e. define the objects at compile time) can manipulate such a hierarchy.

In a proposed hierarchy model 1350 shown in FIG. 14, the Scene Graph model is extended to be completely type-agnostic, even at run-time. Instead of connecting class-based items (1360, 1362, 1364, 1366, 1368) through well-defined data structures, the proposed Hierarch (Virtual File System) only relies on the concept of Virtual Files (1322, 1324, 1326, 1328, 1330, 1332) to denote hierarchy, and a well-described structure for data storage within the Virtual Files.

At any given time, a type specification mechanism attaches rendering and editing functionality based on the data each node encapsulates. As such, any Virtual File can change its type dynamically, by storing additional chunks of data. The type-specification mechanism will re-evaluate a Virtual File when its contents have changed and attach type-specific functionality.

This allows for data to be stored hierarchically and manipulated without prior knowledge of the information they encapsulate. At any given moment, those data can be assigned a type, based on the available modules of functionality the system has currently loaded.

When the same hierarchy is transmitted and loaded in a remote computer, the data can be interpreted differently, based on the modules available on the remote system. This way, two systems may interpret the exact same hierarchy in significantly different ways and still be able to exchange, manipulate and edit data. Systems that do not implement specific functionality can still manipulate the same hierarchy and transmit all Virtual Files to other computers.

Authoring System Functions

Real-Time Distributed Multi-User Collaborative Editing

According to an exemplary embodiment, two or more users of a 3D authoring system may collaborate in real time from remote locations.

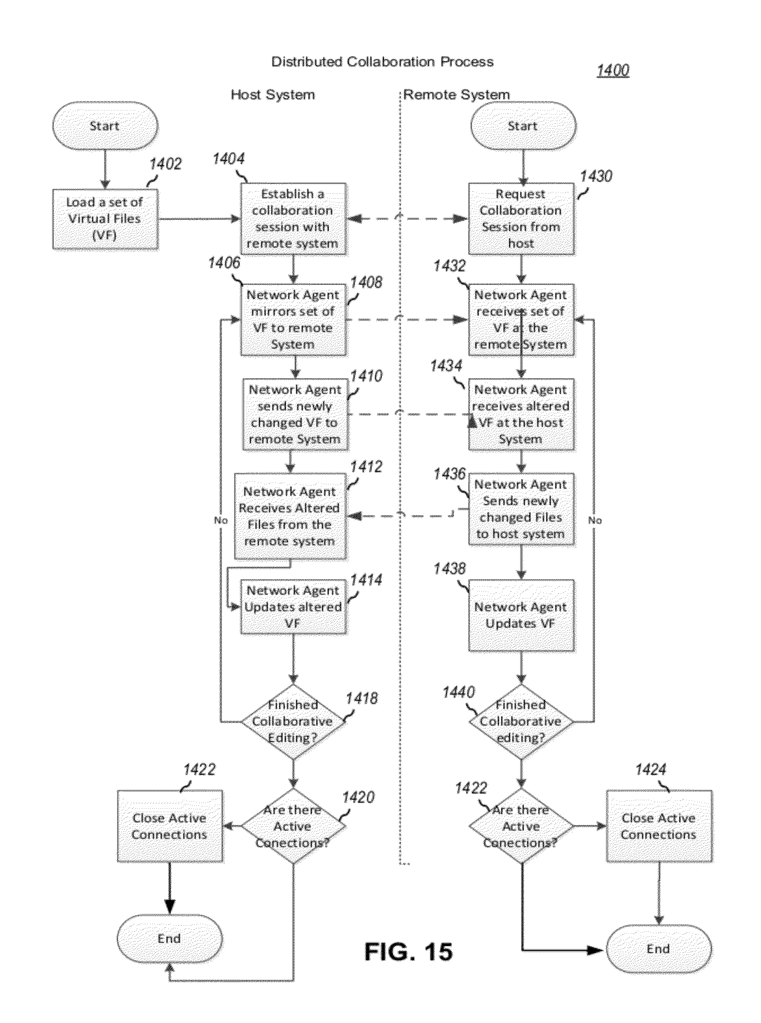

FIG. 15 shows a distributed collaboration process 1400 in accordance with an exemplary embodiment. We refer to this form of collaboration as Collaboration Model. According to the Collaboration Model, a first user, acting as a host, initiates a first editing session by loading a set of virtual files into the memory of the first user's system, in step 1402.

In step 1430, a second user requests a connection to the first user and initiates a second editing session. The network agent module (NAM) of the second user sends the request to the network agent module of the first user. The NAM of the first user transmits (mirrors) a copy of the set of virtual files to the NAM of the second user, in step 1408. The NAM of the second user loads the received set of virtual files into the memory of the second user's system in step 1432. Now each user's system has the same set of virtual files in corresponding memory.

Each user initiates an independent editing session and accesses a different VF for editing. Each user may, then, visually monitor the changes that the other user is effecting on the corresponding authoring system session. In step 1410 NAM send a newly changed VF to the remote system. In step 1434 the NAM of the remote system receives the altered VF at the host system.

In a similar manner, in step 1436 the NAM of the remote system sends a newly changed VF to the host system. Then, in step 1412 the NAM of the host system receives the altered files from the remote system. In step 1414 the NAM of the host system and in step 1438 the NAM of the remote system update each altered VF, respectively.

Each of the host and remote system checks, in steps 1418 and 1440, respectively, if the collaborative editing is finished. If the collaborative process is finished then there is a check performed, in steps 1420 and 1422, respectively for active connections.

If there are active connections then in steps 1422 and 1424, respectively, they are closed and the process ends. Both sessions remain up-to-date in real time. In practice each user becomes a virtual user to the remote authoring system.

Each session of the authoring system considers two users as active users in the session. The NAM module represents the remote user in each session. Furthermore, the NAM module is responsible for delivering all VF changes effected by the local user to the NAM of the remote user so that the remote NAM will effectuate synchronization between the two sessions.

During the collaborative session, as well as at the end of it, both users have identical VFs in their system. The apparent benefit of the collaborative function is that, in contrast to the prior art, each user visualizes in real time the changes effected by the remote user. This speeds up and facilitates production as no user needs to wait until other users finish their work.

The Collaborative Model is facilitated with the introduction of the Connection Panel. Through the Connection Panel, users can connect to remote authoring systems, see the currently edited data and make arbitrary changes on that data in the exact same manner as local data are edited.

In order for remote collaboration to be initiated, two or more properly configured systems must be connected through a compatible computer network. The systems may be connected over a local area network or through the Internet. It is presumed that each system is properly configured to connect and authenticate to each remote system (i.e. each user has been given a set of credentials and knows the network address of the systems they are required to connect to). Hereafter, reference will be made to each of the connected systems as “Node”.

The Authoring System (Node) that the current user is operating on will be called the “Local Node”. All the other, non-local nodes will be called “Remote Nodes”. In this context, the term “Node” refers to an instance of the editing environment, running within a computing system.

It should be noted that it is possible for multiple instances of the invention (Nodes) to be executed within one computing system and remain connected as discussed above. As long as a network interface (virtual or physical) exists between the nodes, any connection layout is valid and proper for the purpose of the invention. Thereby, without loss of generality, it can be safely assumed that each Node (instance of the invention) runs in a properly connected computing system.

To manipulate remote data, users must enter connection data of the remote node they want to connect with, in the Local Node's connection panel. The required data are the remote node's address, and a set of credentials (user-name and password). When properly connected and authenticated, a routine on the Local Node will request a collaboration session on the Remote Node. This will initiate a data transfer, and the Local Node will add all publicly available Virtual Files of the Remote Node to its local set of Virtual Files. Those files can then be edited locally. A system routine manages and updates those files to and from the Remote Node. If edits have been done to the Local Node, the changed parts of the Virtual File are updated on the Remote Node. If changes are being made on files on the Remote Node, those changes are reflected back on the Local Node.

To simplify data handling and ensure optimal performance, only one user is allowed to edit a Virtual File at any given time. It is worth noting that every media project comprises of several independent media object elements. Thus, at any given time, several Virtual Files are available for editing. As a result, constraining editing to one user per Virtual File does not hamper the collaborative process.

When a user starts editing a Virtual File, a signal is transmitted to all connected Nodes, informing all Users that the specific file is being “locked”. If, during that process, one of the remote nodes discovers that the specific file is being edited (meaning that it has already been locked but the lock signal is stalled) then a lock failure will be issued on the local node, thus cancelling any edit actions from the User. To inform all users as to what files are locked, a lock icon is added beside the Virtual File icon in the browser window. To support this collaboration model, the authoring system uses the Network Agent Module (NAM) that acts as Virtual File server and client and is based on the Virtual File System (VFS) module. The Network Agent Module observes user interactions and senses whether the user is modifying locally or remotely hosted files. It does so transparently to the User Interface system, which is mostly unaware of the Networking part.

The Virtual File System provides a specific data model for the Virtual Files and manages file collisions (Virtual File locking). The Network Agent Module acts like a local user within each system, translating all remote edits into properly configured, local ones. This approach not only provides a seamless abstraction layer between the User, the Virtual File System and the Collaborative Environment, but also enforces security and simplifies development of custom media types and modules (since developers need not take networking into account when developing new tools for the authoring system). The Network Collaboration is handled transparently by the Network Agent Module, which automatically communicates with its peer Modules across the network, keeping track of all changes.

In the 3D Video Game example, a 3D scene would be comprised of several 3D Models, several Materials and some Lights. Each 3D-Modeling artist would perform edits on their assigned 3D Models, while texture artists would define the appearance of each 3D model, by editing the corresponding Material Virtual Files. This workflow mimics the actual production pipeline of a production studio, where each artist is handed with the development of a specific part of a 3D scene.

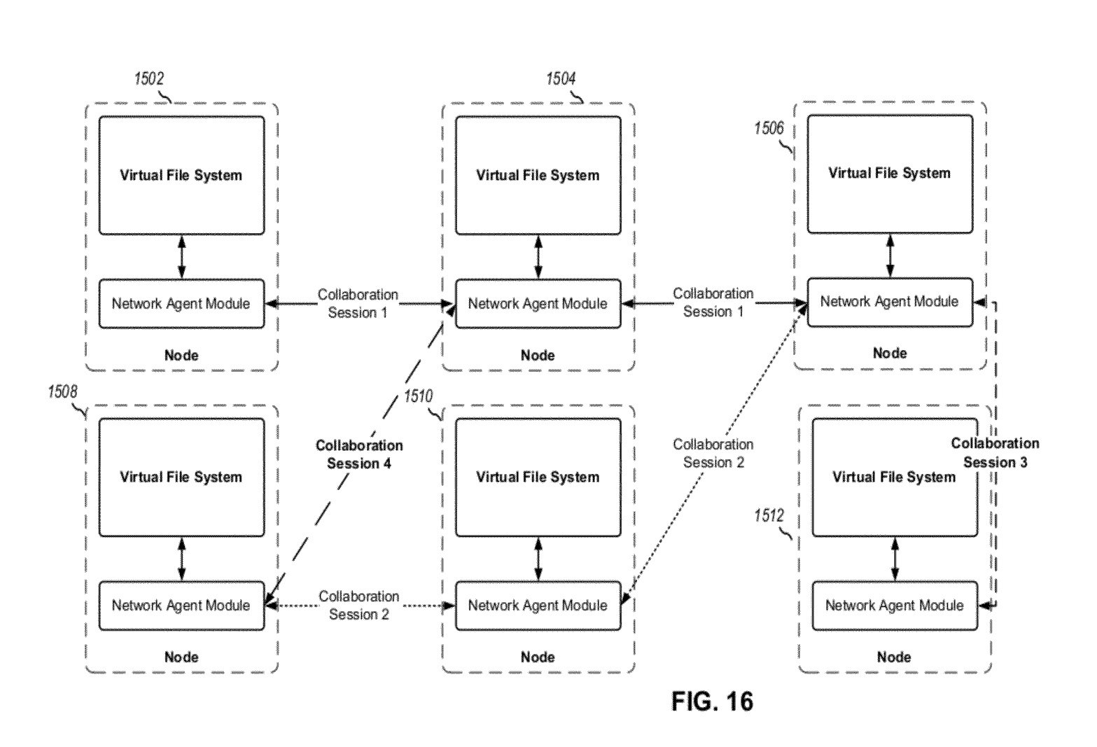

FIG. 16 illustrates a set of peer-to-peer collaboration sessions in accordance with an exemplary embodiment. A set of nodes (1502, 1504, 1506, 1508, 1510, 1512) correspond to users who create a network of peers. Each of the nodes includes a Virtual File System connected to a Network Agent Module (NAM).

Each node may act as a host or as a client in a collaborative session. Each node when acting as a host includes means for means for establishing a communication session with a client device to edit collaboratively a set of virtual files, means for mirroring to the client device a copy of the set of virtual files, and means for receiving, from the client device, a change to one of the virtual files in the mirrored copy at the time it happens and automatically updating the corresponding virtual file in the host device to facilitate real-time collaborative editing.

Furthermore, each node when acting as a host may include means for editing the set of virtual files, means for detecting a change in a virtual file and mirroring the change to the client device at the time it happens and means for rendering the set of virtual files to present a 3D content. Each node when acting as a client includes means for establishing a communication session with a host device to edit collaboratively a set of virtual files hosted at the host device, means for receiving, from the host device, a mirrored copy of the set of virtual files, means for editing the set of virtual files, and means for detecting a change in one of the virtual file in the mirrored copy and reporting the change to the host device at the time it happens to facilitate real-time collaborative editing.

Furthermore, each node when acting as a client may include means for editing the mirrored copy of the set of virtual files and means for receiving, from the host device, a change to one of the virtual files at the time it happens and automatically updating the corresponding mirrored copy of the virtual file in the client device.

In the example of FIG. 16, node 1504 initiates a first collaborative session with node 1502 and node 1506. Node 1504, acting as a host, establishes a communication session with each of the nodes 1502 and 1506 to edit collaboratively a set of virtual files. Each node includes means for mirroring a copy of the set of virtual files. Each Network Agent Module monitors the set of virtual files. Whenever a change to one of the mirrored copies of virtual files is detected by one of the NAMs a message is sent to the host node to indicate this change. Then the host node propagates this change to the rest of the nodes and the mirrored virtual files are updated automatically in real time.

In the example of FIG. 16, node 1510 initiates a second collaborative session with node 1506 and node 1508. Therefore, node 1506 acts as a client to both collaborative sessions. However, node 1506 initiates a third collaborative session with node 1512 acting as a host. Therefore, it is possible a node to act as a host for one collaborative session and as a client for another collaborative session. A fourth collaborative session is initiated by node 1504 where node 1508 acts as a client.

Referring to of FIG. 16, it can be seen that users create a network of peers. Each user's node may act both as a host and as a client, connecting on demand to other nodes in the network. Authentication data are stored locally within each node. Users have to manually connect and authenticate to a remote system in order to access its real-time media data.

Once connected to a remote system, a user's node acts as a hub and automatically relays data from the remote system to all the remote Users connected to it. This way, a distributed network is formed that allows users to edit and visualize remote data (Virtual Files) seamlessly, as if they were stored locally. Changes in the data are propagated through the distributed network back to the original data host.

The peer-to-peer model is optimal for online collaboration of small groups. Because need for collaboration arises spontaneously (i.e. when data need to be exchanged between colleagues or when review and advice is needed), the speed and flexibility of the peer-to-peer model ensure better performance whenever two colleagues need to collaborate. They are now able to connect to each other and do on-line editing using the editing workflow already discussed without affecting any other team member. By creating small, task-specific collaboration networks, teams focus on the current set of media being edited without performance penalties in network traffic and processing resources.

In the 3D Video Game Development example, two colleagues may choose to initiate an online collaboration session to mutually review their work and do simultaneous development, in 3D Models currently developed or in new 3D Models. This will allow them to achieve the required visual style and polished look faster.

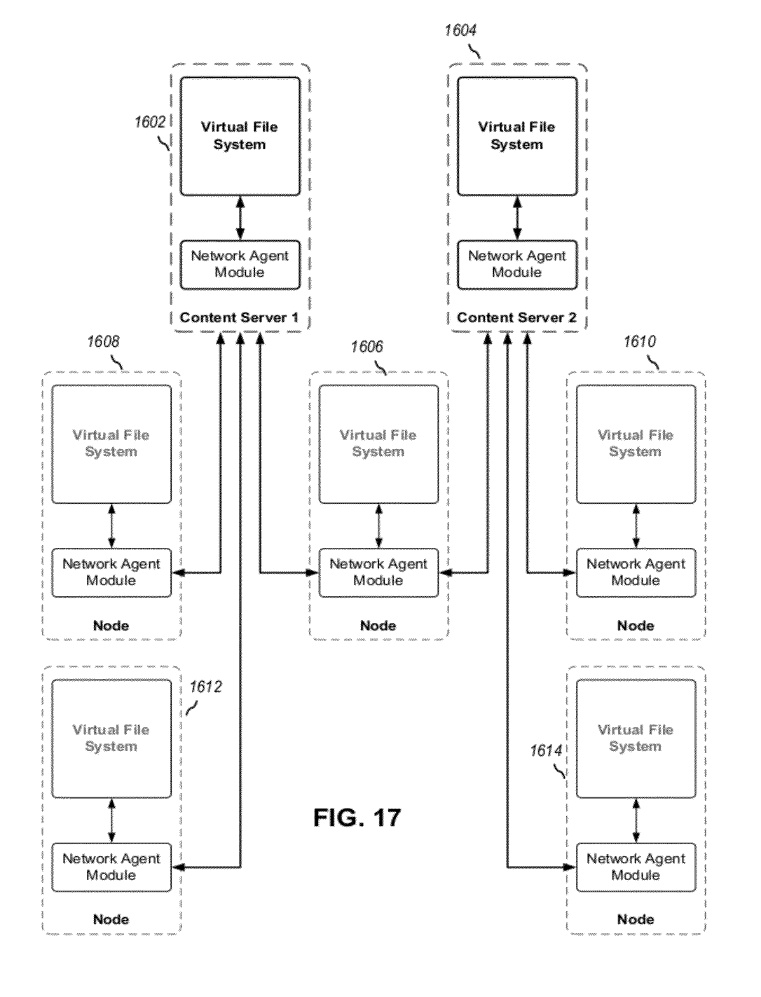

FIG. 17 illustrates a collaboration session based on a central server model. In addition to the peer-to-peer model of collaboration, the proposed architecture allows for a central computer to act as a media-editing server. Here, all authentication data are stored centrally, as are the media data (Virtual Files). By nature, media data are resource-intensive to render, which would in turn impact overall performance. However, the media server can be configured appropriately, so that no media rendering takes place, thus using minimal resources, while hosting the entire set of Virtual Files currently available for editing. Nodes 1602 and 1604 act as content server 1 and content server 2, respectively. In the example of FIG. 17, nodes 1608, 1606 and 1612 initiate a collaborative session with node 1602 acting as content server 1. Nodes 1606, 1610 and 1614 initiate a collaborative session with node 1604 acting as content server 2. As illustrated, node 1606 may be part of two collaborative sessions simultaneously.

Team members connect and authenticate to the central server to view and edit any of the available Virtual Files. To ensure optimal performance and minimal workflow problems, a strict permission model is enforced. Senior team members set appropriate permissions for Virtual Files and team members and oversee the editing process.

The server-based model is ideal when a relatively large team accesses random files from a common pool. In the example of a 3D Video Game Development project, the Art Director would load a particular scene (or range of scenes) in the central server and assigns permissions for each team member and Virtual File, thus assigning jobs to users. Then, users can connect on the server and edit their assigned 3D media data concurrently. The Art Director would be able to supervise the editing process by connecting to the central server and reviewing changes as they happen. When the current editing session is finished, the scene is exported (saved) and a new scene is loaded on the server. Although the Central Server has no means of visualizing the Virtual Files it hosts (since no respective Virtual File Handle module has been loaded to reduce resource requirements), it has all the necessary management and delivery functionality since the core Virtual File system is type-agnostic and interacts with the Virtual Files in an abstract way.

It should also be noted that the two remote users that work in a collaborative session may work on the same scene with the same tools or may work on the same scene with different tools as long as they work on a different VF.

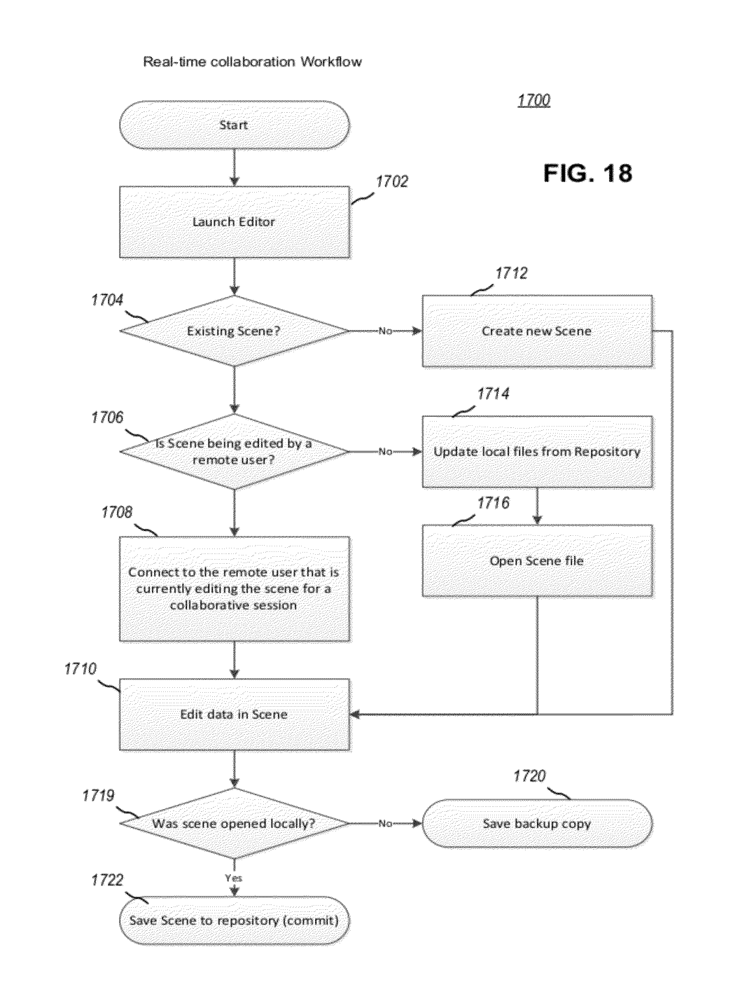

FIG. 18 graphically depicts real-time collaboration workflow 1700 of a scene in accordance with an exemplary embodiment.

Referring to workflow 1700, the editor of the authoring system is launched (step 1701). It is next determined if the scene to edit is an existing scene or not (step 1704). If the scene is an existing scene then the authoring system determines if the scene is being editing by a remote user (step 1706). In step 1708, the authoring system connects to the remote user and establishes a collaborative session, allowing both the local and remote user to edit concurrently the scene as shown in step 1710. If the scene is not being edited by a remote use then, in step 1714, the local files are being updated from a repository and in the next step (step 1716), the scene file is opened, to enable editing of the scene as shown in step 1710. If the scene does not exist the user may create a new scene, in step 1712 and continue editing the scene in step 1710. In step 1710, the authoring system determines if the scene file was opened locally. If the scene file was opened locally then, in step 1722, the scene is saved to the repository. If the scene file was not saved locally, then, in step 1720, a back copy of the scene file is saved.

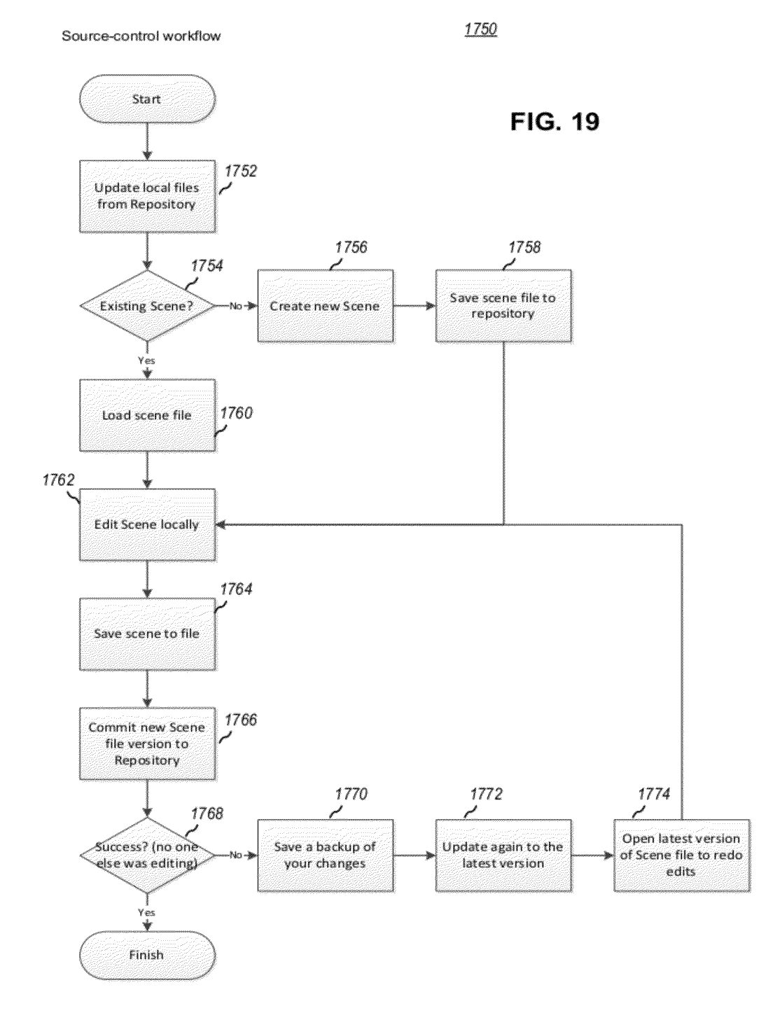

FIG. 19 graphically depicts a conventional source control workflow 1750 of a scene.

According to workflow 1750, at the initial step 1752 the conventional authoring system updates the local files from a depository. Then, at step 1754, the conventional authoring system determines if the scene is an existing scene or not. If it is an existing scene then, in step 1760, the user loads the scene file and in the next step, step 1762, edits the scene locally. If the scene is not an existing scene, then in step 1756, the user creates and new scene file and in step 1758 saves the scene to the repository so the user can edit the scene in step 1762.

The user saves the scene to a file, in step 1764 and the authoring system commits a new version for the scene file to the repository, in step 1766. The authorizing system determines in step 1768 if the new version of the scene file was successful or not based on whether a second user is editing the scene file. If no user is editing the scene file then the scene is successfully saved and the editing of the scene is considered completed. If a second user is editing the scene then the first user must, in step 1770, save in a backup file the changes performed on the scene file.

Then in step 1772, the user must update its local authoring system with the latest version of the scene file and at the end open the latest version of the scene file, in step 1774, to edit again the changes to the scene file.

It should be appreciated that unlike a conventional authoring system based on source control work flow, the authoring system disclosed herein allows multiple users to simultaneously edit a scene.

Real-Time Multi-User Concurrent Editing and Playing

In yet a further exemplary embodiment, one or more users are editing a scene while the 3D application is executing. The concurrent editing and execution is a key function enabled by the modular nature of the architecture. As the underlying Core Framework and kernel are the same, a user needs only execute in parallel an editing module and an application module. In such a way, changes made to a scene (i.e a set of Virtual Files) are rendered and visualized in real time in a substantially seamless way without a need to pause the application, let alone closing and reloading.

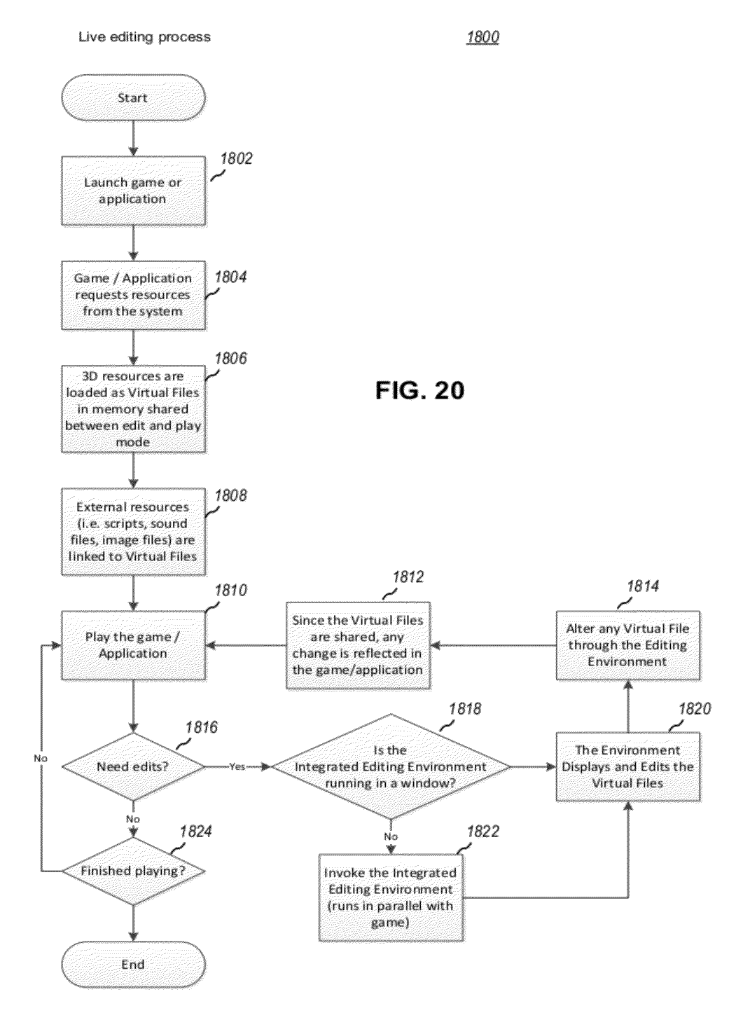

FIG. 20 illustrates a live editing process during which edit mode and play mode are executed at same time. In a first step 1802, a game or application is launched. Then, in step 1804, the game or application requests resources from the system. In step 1806, 3D resources are loaded as virtual files in memory shared between edit and play mode. In step 1808, external resources, such as scripts, sound files or image files, are linked to virtual files. In step 1810 the game or applications begins to play. In step 1816, a decision is made on whether there is a need for editing.

If yes, then a check is performed, in step 1818, if an integrated editing environment is open. If no, then in step 1822 the integrated editing environment is invoked and runs in parallel with the game or application. In step 1820, the integrated editing environment displays and edits the virtual files. In step 1814, at least one virtual file is altered through the integrated editing environment. In step 1812, the change is reflected in the game (or application) as the virtual file is shared between edit and play modes. If no more edits are required, in step 1816, then if the user wants to finish playing, in step 1824, the process ends. Otherwise the process returns to step 1810.

Cross-Platform Operation

In a further embodiment, only selected modules are loaded onto a user's device based on the user's platform. The selection of the modules may, for example, be based on the embedded device's hardware or software capabilities as a function of processing instructions per second. Furthermore, the selection of the modules may be based on the peripheral functionality of a user's system (such as monitor resolution or joysticks). Alternatively, device-specific Modules are loaded and attached to specific Virtual Files, so that the scene is rendered in a device-optimized manner.

Customized Editing and Rendering

In a further embodiment users concurrently running an application in a network are allowed to have custom modules for handling VFs. This allows for different user experience based on the capabilities or the user's system or simply based on the desire of the user. A custom module may render a VF in a substantially different way than modules executed in other user systems. The different rendering does not affect the networking aspect of the application. That is, the other users may not be aware of the different rendering possibility of the user running the custom module and the execution of the custom module does not affect the other users of the system. An exemplary set of custom modules would be device specific VFH modules for the entry-level mobile devices, or “modified” rendering system that overlays additional information to the game tester (for example, coloring by scene complexity). These VFH modules may be dynamically downloaded during execution of the application.

Seamless Real-Time Collaboration with External Content Creation Programs

In yet a further embodiment a plug-in module enables a collaborative session between two programs on the same computer in real-time. The two programs may be a typical content creation program instance and an authoring system instance according to the proposed invention.

A user installs a plug-in module to the content creation program he or she is familiar with. The plug-in includes a thin version of the authoring system comprising the Core Development Framework, the kernel and the NAM. The plug-in initiates a collaborative session where the NAM of the plug-in communicates with the corresponding NAM of the authoring system. Therefore the authoring system treats the plug-in as a remote user and “collaborates” with the third-party program again in a seamless way. With this function a user needs a minimum amount of effort for contributing changes to a VF, as the changes are realized via a program he or she is already familiar with.

As the system supports dynamic data exchange with live update in real time between two users, across the network, similarly it supports dynamic data exchange between applications running in the same environment. Because the system can use IP sockets to provide real time collaboration capabilities, it can be expanded as follows: (i) Create a plugin module for a Content Creation Program, so that the Content Creation Program makes use of the VFS Kernel (ii) Create a conversion filter that translates 3D data from the Content Creation Program to the VFS Kernel (iii) Use the Authoring System Kernel on the plug-in to connect to an external Authoring System, which may rely on the network, or on the local computer; and (iv) Make it so that every change on the program's content translates to an incremental change in the plug-ins VFS kernel.

The VFS Kernel on the plugin module will automatically relay the change in the 3D content to the external Authoring System, using the Authoring System's Remote Collaboration components as described.

The aforementioned functionality can be used to automatically transmit and update 3D content between a content creation program (such as Softimage XSI, Autodesk Maya, Autodesk 3DS Max) and the VFS Kernel. Since any change happens incrementally, the latencies for updating the 3D content on the external Authoring System are significantly lower to saving the entire scene in a file. However, the real benefit of this system is the fact that the user does not need to manually export a file from one program and import it in the other. The update process happens transparently and automatically.

Using the system described above it is possible to create interfaces to popular 3D content creation tools that will automatically transmit 3D content back to the Authoring System's 3D editing system. However, the system may also provide a common bidirectional data exchange link, if the proper translation filter between the Content Creation Program and the VFS Kernel is introduced. This is possible if the step (ii) above is changed as follows: “Create a conversion filter that translates 3D data from the Content Creation Program to the VFS Kernel and from the VFS Kernel back to the Content Creation Program”.

Then any changes done within an Authoring System program can be automatically imported back on the Content Creation Program. Naturally, this requires a proper plugin module for the Content Creation Program; a plug-in that manages synchronization of data between the encapsulated VFS Kernel and the Content Creation Program itself.

The system described above is beneficial to anyone intending to export their 3D content for use within the Authoring System 3D platform. However, the same solution allows for real-time collaboration and interoperability between any 3D content creation programs, even across the network. The above system can be upgraded as follows: (i) Create a plugin module for a Content Creation Program #1, that makes use of the VFS Kernel (ii) Create a conversion filter that translates 3D data from the Content Creation Program #1 to the encapsulated VFS Kernel and from VFS Kernel to the Content Creation Program #1 (iii) Create a plugin module for a Content Creation Program #2, that makes use of the VFS Kernel. (iv) Create a conversion filter that translates 3D data from the Content Creation Program #2 to the encapsulated VFS Kernel and from VFS Kernel to the Content Creation Program #2 (v) Connect the VFS Kernels of Content Creation Program #1 and #2.

The VFS Kernels will automatically transmit and delegate any change in the 3D Content, properly syncing 3D content between each other. As long as the encapsulating plug in module for each program exports those changes back to the Content Creation Program itself, it is possible to achieve remote collaboration in real time between two programs, using the Authoring System as the linking system for data transport. This collaboration solution can work as-is both in the case of network-based collaboration and in the context of one machine running multiple content creation programs. Thus, it benefits not only teams of artists, but single artists using one system as well.

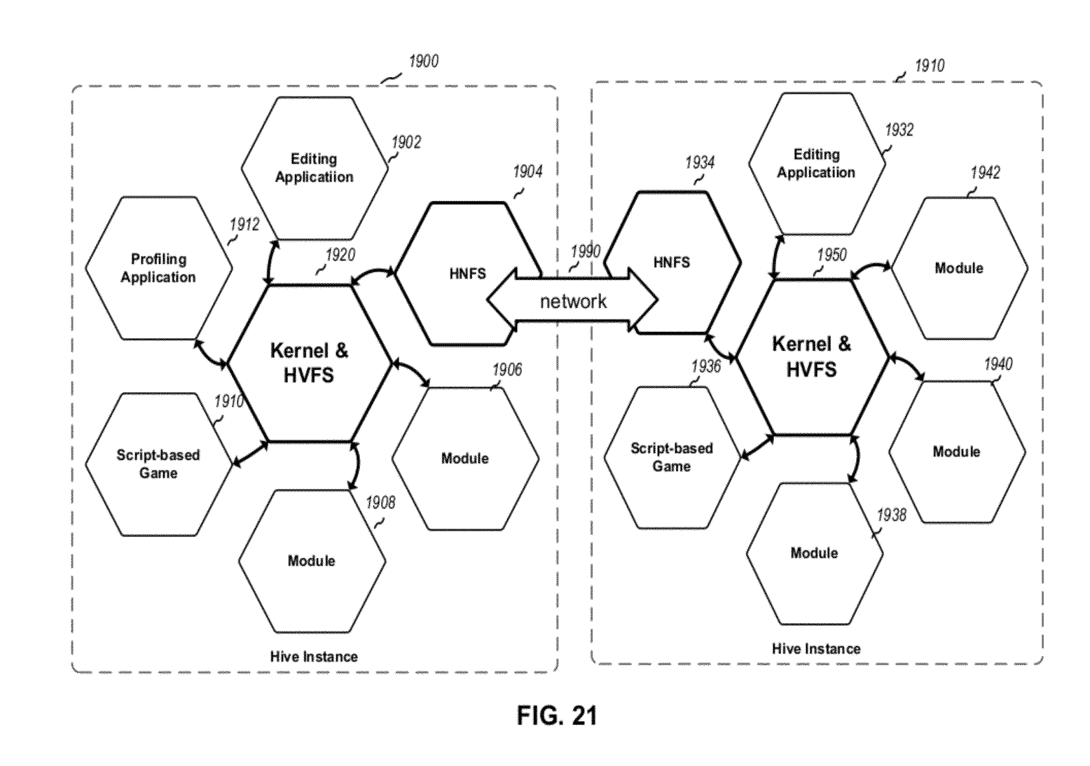

FIG. 21 describes a dynamic data exchange between two different applications in accordance with an exemplary embodiment.

A first instance 1900 and a second instance 1910 of a content creation program initiate a collaborative session via network 1990. First instance 1900 includes Kernel and Virtual File System module 1920, Profiling Application module 1912, Script-based game module 1910, NAM 1904 and other modules 1906, 1908. Second instance 1910 includes Kernel and Virtual File System module 1950, Script-based game module 1936, NAM 1934 and other modules 1938, 1940, 1942.

The other modules are simply shown for illustrative purposes and play no role for the dynamic data exchange between applications. First instance 1900 includes editing application 1902. Second instance 1910 includes editing application 1932. In the example of FIG. 19, editing application 1902 is different from editing application 1932. According to an aspect of this invention, editing application 1902 edits a 3D media content to create a 3D object representation. Then, Kernel and Virtual File System module 1920 translates the 3D object representation into a virtual file. Then, NAM 1904 mirrors the virtual file. Then it communicates with NAM 1934 to transmit the mirrored virtual file to create a copy of the virtual file at second instance 1910. Similarly, at second instance 1910, editing application 1932 edits a 3D media content to create a 3D object representation. Then, Kernel and Virtual File System module 1950 translates the 3D object representation into a virtual file. Then, NAM 1934 mirrors the virtual file. Then it communicates with NAM 1904 to transmit the mirrored virtual file to create a copy of the virtual file at first instance 1900.

A communicated virtual file may or may not require translation to be edited by an editing application at another instance. Should the editing application be able to edit virtual files directly, then no translation is necessary. Otherwise, appropriate translation of the virtual file takes place so that the editing application is able to edit the translated virtual file.

Modular DRM Control

In a further embodiment a module may allow users with different access rights to render a VF in a different way (or not at all). A module digital rights management algorithm may facilitate at least one of (i) user ID specific access, (ii) computer specific based access (e.g., IP or MAC address specific), (iii) time based access (TRIAL VERSION ACCESS); (iv) location based access, whereby for example, certain casino games, rated games, applications with export restrictions and the like, may require modules to be inactivated or non-downloadable in a particular territory. This is desirable because game developers In order to maximize profit, target games for the largest possible audience. The modular nature of the 3d authoring system allows developers to expand the feature sets to allow region friendly alternatives of a particular game or application.

Social Networking

Augmented with an execution framework that targets web-oriented architectures (including web browsers and mobile devices), 3D applications developed in the context of the invention can be made to run in network-based platforms.

More specifically, the presently disclosed exemplary embodiments can be attached to social networking applications and web technologies through the use of modules and connecting libraries.

In this context, access to network based content and code is simplified, since all the necessary networking and web-interfacing infrastructure is provided as building blocks by the invention.

Another benefit of the architecture is that development of 3D games and applications happens in a platform-agnostic context, allowing the deployment of the game or application in a target computing device using a relevant execution framework (coupled with device-specific modules).

Ecommerce

The presently disclosed exemplary embodiments provide greater flexibility in integrating ecommerce and advertising solutions in a 3D environment. In one example, proprietary ecommerce (revenue share) solutions can be created to take advantage of the true live editing functionality described above.

Since gaming components can be downloaded on the fly and used dynamically and interchangeably as building blocks for games, it is possible for 3rd parties to implement such functionality.

Moreover, game-related components can be presented to the users in a context sensitive environment, where the term “context” may refer to location, product, game state, visible content or player-profile status:

Some example scenarios include:

1. Users of a specific region entering a specific game area may be presented with different advertisements and with different purchasing options than gamers of other regions.

2. Game-context sensitive product placement: advertising and product offering depending on game state—for example chooses to drive a car in a racing simulator game, he may be allowed to choose between two branded cars

3. Live content placement: Advertising and product offering content may change dynamically while the game is running For example, the billboards in a virtual football game may display alternative ads dynamically, depending on the user profile or other relevant parameters.

4. Location-specific game goals. For example, in a quiz game about movies, players may be presented with purchasing options (paraphernalia, avatar enhancements etc) when entering famous star or movie locations.

Another example is a global avatar system, tied-in with the gamer's social profile (i.e. Facebook, MySpace or OpenSocial profile). An avatar game component, residing in a 3rd party server, displays an avatar using profile parameters (bound to the player's profile). This avatar can be used as is by third-party game developers, in their games. However, the same avatar system may allow third party game developers to alter the appearance of the player's avatar to make it conform to their game's aesthetics. This in turn allows third party game developers to provide avatar add-ons that are related to their game: As a result, a player may purchase a “sheriff” hat from a far west game and take that hat to another game, as long as it is allowed by the other game developer.

The combined user friendly nature of the authoring system and enhanced functionality (live editing, real time collaboration, and platform extensibility, etc.) can drive old types of advertising and ecommerce solutions faster, and also drive new models never before possible.

Distributed Gaming

Since third-party game resources can be downloaded on the fly over the network, it is feasible to aggregate several network game resources in a single game, in a fashion similar to distributed computing. In this context, it is possible to use different web-3d services (game content providers), each tied in with a different game component server to implement a composite game.

For example, the following scenario is possible: (i) Use an avatar system hosted by a third party game component provider A. All the user-related data of the avatar are then hosted on game component provider's A infrastructure. (ii) Use a real-time chat system hosted by a third party game component provider B. Provider B is responsible for providing chat functionality and keeping tracks of logs (iii) Use an advertising system hosted by a third party game component provider C. All advertisements are downloaded by provider C's system and seamlessly integrated in the game. (iv) Game developer D aggregates all services in a single game. (v) The developers agree on providing 3D gaming services for a flat fee (paid by developer D) or in a revenue-share basis (managed by a unified billing system).

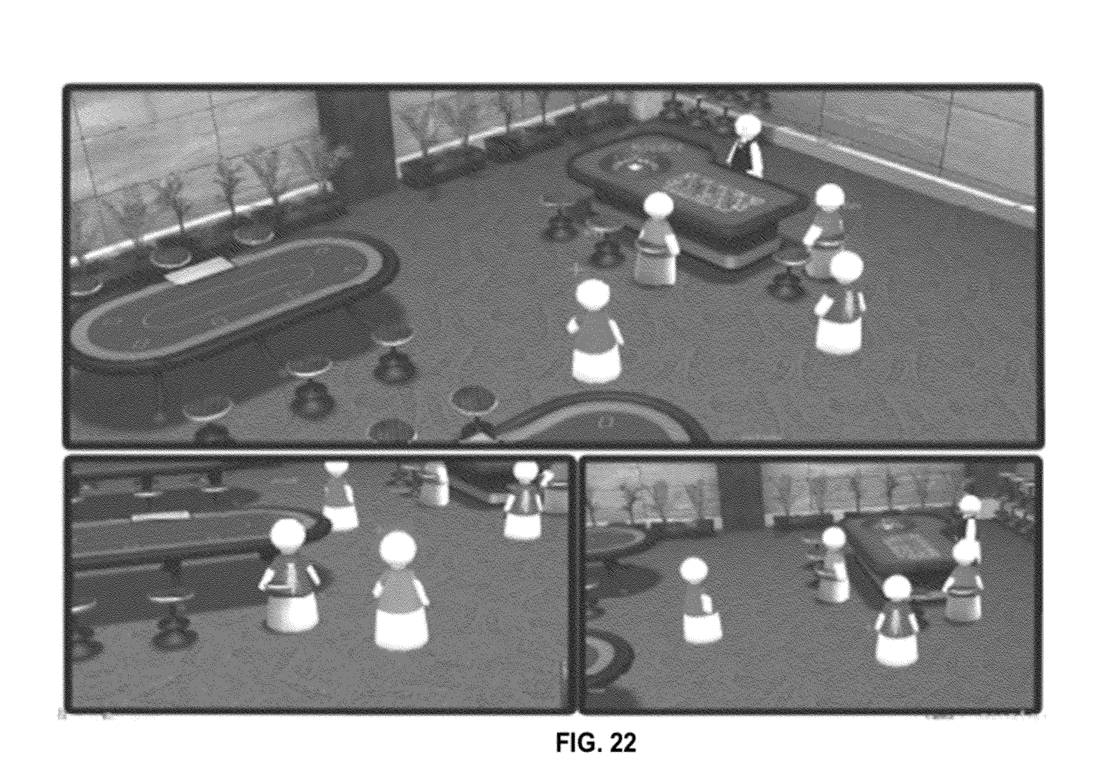

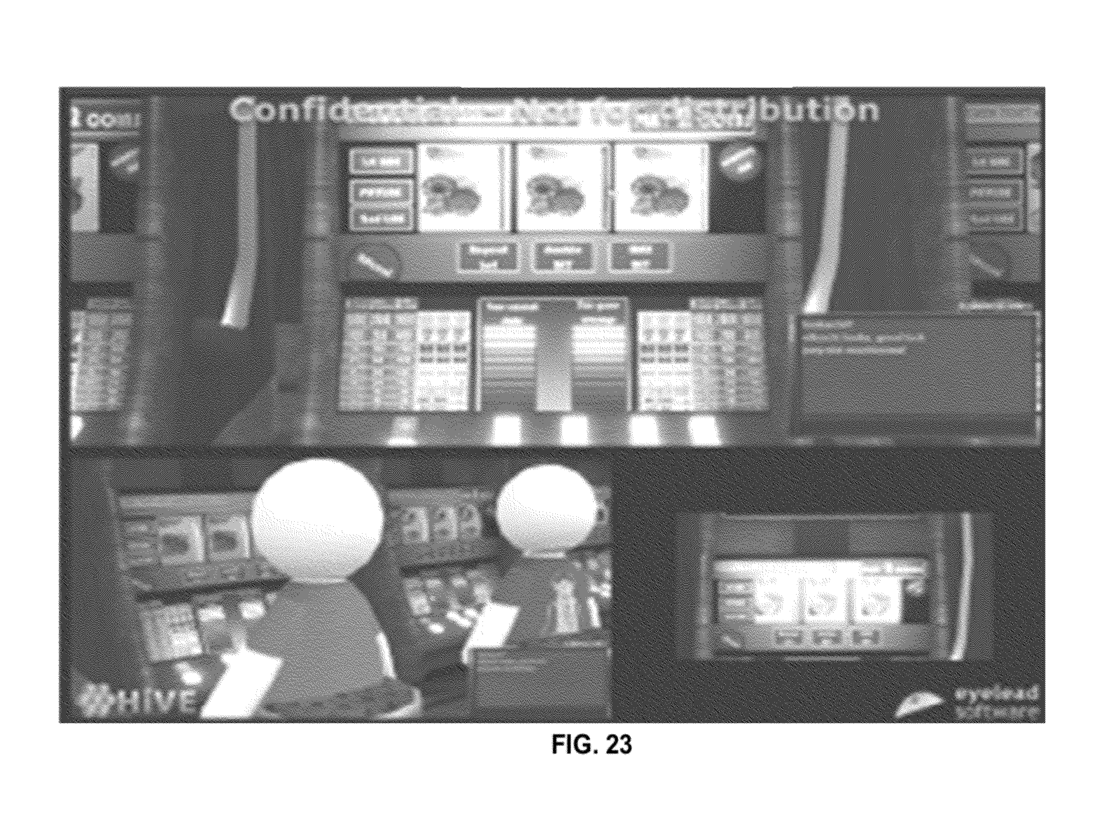

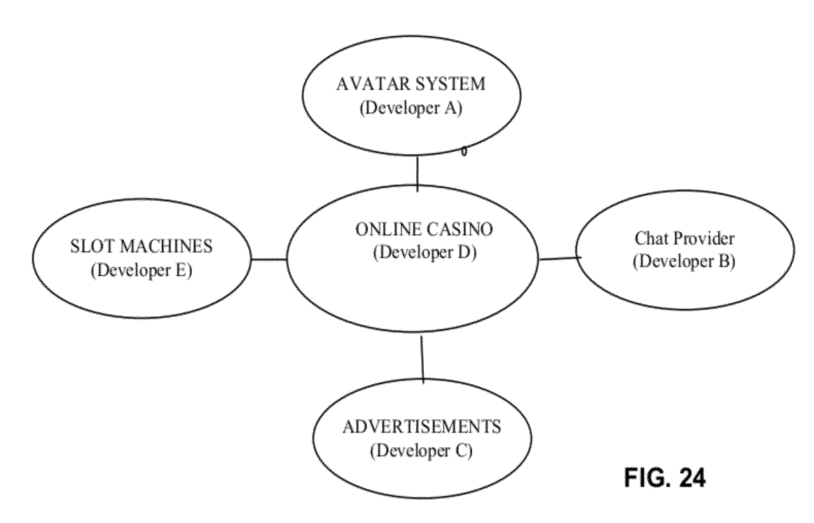

FIGS. 22-24 are screen shots of a massively multiplayer online game with a casino gaming theme created using a 3D authoring system in accordance with an exemplary embodiment.

In an exemplary embodiment, a Developer D provides all massively online presence infrastructures, including the places and halls of a Casino. Developer A provides the Avatars and the customization system, which may link characters to social networks (Facebook, OpenSocial or otherwise). Real time chat is hosted by Provider B and advertisements are handled by provider C. A fourth game content provider E creates random-number-accurate slot machines (both content and logic) which are then hosted in Developer's D casino. Revenues are split between E and D, while A, B and C provide their service for a flat monthly hosting fee.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer readable media encoded with a plurality of virtual files each representative of different 3D media objects renderable by a computer, each virtual file having a data structure including:
first data defining a first set properties of a 3D media object which during a rendering session are not impacted by a change to a second set of properties;
second data defining the second set of properties of the 3D media object; and
linking data to link the virtual file, during the rendering session, to other virtual files of other 3D media objects having similar data structures.

2. The computer readable media of claim 1, wherein the first data are categorized as non-frequently changing during rendering.

3. The computer readable media of claim 2, wherein the first data represent the surface of the 3D object.

4. The computer readable media of claim 1, wherein the second data are categorized frequently changing.

5. The computer readable media of claim 4, wherein the second data represent one of a position, a rotation or a scale of the 3D object.

6. The computer readable media of claim 1, wherein the linking data are categorized as non-frequently changing during rendering.

7. The computer readable media of claim 6, wherein the linking data includes links to other virtual files that represent one of a light, a material or a color of the 3D media object.

8. A method of encoding a plurality of virtual files each representative of different 3D media content to be rendered by a computer, each virtual file having a data structure including first data defining a first set properties of an object which during an editing session are not impacted by a change to a second set of properties; second data defining the second set of properties of the object; and linking data to link the first and second sets of properties, during the editing session, to other virtual files of other objects having similar data structures.

9. The method of claim 8, wherein the first data are categorized as non-frequently changing during rendering.

10. The method of claim 9, wherein the first data represent the surface of the 3D object.

11. The method of claim 10, wherein the second data are categorized frequently changing.

12. The method of claim 11, wherein the second data represent one of a position, a rotation or a scale of the 3D object.

13. The method of claim 12, wherein the linking data are categorized as non-frequently changing during rendering.

14. The method of claim 13, wherein the linking data includes links to other virtual files that represent one of a light, a material or a color of the 3D media object.

15. A device for encoding a plurality of virtual files each representative of different 3D media objects to be rendered, the device comprising:
means for registering a data structure of a virtual file in a virtual file system, where the data structure includes first data defining a first set of properties of a 3D media object which during an editing session are not impacted by a change to a second set of properties, second data defining the second set of properties of the 3D media object, and linking data to link the first and second sets of properties; and
means for identifying the virtual file belonging to the registered data structure during an editing session.

16. The device of claim 15, further comprising means for matching the virtual file with a corresponding registered data structure.
